(19) United States
(12) Patent Application Publication
(10) Pub. No.: US 2013/0077086 A1
(43) Pub. Date: Mar. 28, 2013

(54) Solid-State Laser And Inspection System Using 193nm Laser

(71) Applicants: Yung-Ho Chuang, Cupertino, CA (US); Vladimir Dribinski, Livermore, CA (US); J. Joseph Armstrong, Fremont, CA (US)

(72) Inventors: Yung-Ho Chuang, Cupertino, CA (US); Vladimir Dribinski, Livermore, CA (US); J. Joseph Armstrong, Fremont, CA (US)

(73) Assignee: KLA-Tencor Corporation, Milpitas, CA (US)

(21) Appl. No.: 13/558,318

(22) Filed: Jul. 25, 2012

Related U.S. Application Data
(60) Provisional application No. 61/538,353, filed on Sep. 23, 2011.
(60) Provisional application No. 61/559,292, filed on Nov. 14, 2011.
(60) Provisional application No. 61/591,384, filed on Jan. 27, 2012.
(60) Provisional application No. 61/603,911, filed on Feb. 27, 2012.

(51) Int. Cl. G01J 3/00; G02F 1/35; G01N 21/47; H01S 3/02; G01N 21/00

(52) U.S. Cl. 356/51; 372/5; 356/237.5; 356/237.2; 356/446; 359/328

(57) ABSTRACT

An improved solid-state laser for generating 193 nm light is described. This laser uses the 6^{th} harmonic of a fundamental wavelength near 1160 nm to generate the 193 nm light. The laser mixes the 1160 nm fundamental wavelength with the 5^{th} harmonic, which is at a wavelength of approximately 232 nm. By proper selection of non-linear media, such mixing can be achieved by nearly non-critical phase matching. This mixing results in high conversion efficiency, good stability, and high reliability.

### RELATED APPLICATIONS

The present application claims priority to U.S. Provisional Application 61/538,353, entitled “Solid-State 193 nm Laser And An Inspection System Using A Solid-State 193 nm Laser” and filed Sep. 23, 2011, U.S. Provisional Application 61/559,292, filed Nov. 14, 2011, entitled “Solid-State 193 nm Laser And An Inspection System Using A Solid-State 193 nm Laser”, U.S. Provisional Application 61/591,384, entitled “Solid-State 193 nm Laser And An Inspection System Using A Solid-State 193 nm Laser” and filed Jan. 27, 2012, and U.S. Provisional Application 61/603,911, entitled “Solid-State 193 nm Laser And An Inspection System Using A Solid-State 193 nm Laser” and filed Feb. 27, 2012.

The present application is also related to U.S. patent application on Ser. No. 11/735,967, entitled “Coherent light generation below about 200 nm” and filed Apr. 16, 2007, which is incorporated by reference herein.

### BACKGROUND OF THE DISCLOSURE

1. Field of the Disclosure

The present application relates to a solid-state laser that generates light near 193 nm and is suitable for use in photomask, reticle, or wafer inspection.

2. Related Art

The integrated circuit industry requires inspection tools with increasingly higher resolution to resolve ever smaller features of integrated circuits, photomasks, solar cells, charge coupled devices etc., as well as detect defects whose sizes are of the order of, or smaller than, feature sizes. Short wavelength light sources, e.g. sources generating light under 200 nm, can provide such resolution. However, the light sources capable of providing such short wavelength light are substantially limited to excimer lasers and a small number of solid-state and fiber lasers. Unfortunately, each of these lasers has significant disadvantages.

An excimer laser generates an ultraviolet light, which is commonly used in the production of integrated circuits. An excimer laser typically uses a combination of a noble gas and a reactive gas under high pressure conditions to generate the ultraviolet light. A conventional excimer laser generating 193 nm wavelength light, which is increasingly a highly desirable wavelength in the integrated circuit industry, uses argon (as the noble gas) and fluorine (as the reactive gas). Unfortunately, fluorine is toxic and corrosive, thereby resulting in high cost of ownership. Moreover, such lasers are not well suited to inspection applications because of their low repetition rate (typically from about 100 Hz to several kHz) and very high peak power that would result in damage of samples during inspection.

A small number of solid state and fiber based lasers producing sub-200 nm output are known in the art. Unfortunately, most of these lasers have very low power output (e.g. under 60 mW), or very complex design, such as two different fundamental sources or eighth harmonic generation, both of which are complex, unstable, expensive and/or commercially unattractive.

Therefore, a need arises for a solid-state laser capable of generating 193 nm light yet overcoming the above disadvantages.

### SUMMARY OF THE DISCLOSURE

A laser for generating ultraviolet light with a vacuum wavelength of approximately 193 nm is described. This laser includes a fundamental source and multiple stages for generating harmonic frequencies. The fundamental source can generate a fundamental frequency of corresponding to a wavelength of approximately 1160 nm. A first stage can combine portions of the fundamental frequency to generate a second harmonic frequency. Where a wavelength value without qualification is given in this specification, it is to be assumed that wavelength value refers to the wavelength in vacuum.

In one embodiment, a second stage can combine portions of the second harmonic frequency to generate a fourth harmonic frequency. A third stage can combine the fundamental frequency and the fourth harmonic frequency to generate a fifth harmonic frequency. A fourth stage can combine the fundamental frequency and the fifth harmonic frequency to generate a sixth harmonic frequency of approximately 193.3 nm. The first stage can include a Lithium triborate (LBO) crystal, whereas each of the second, third, and fourth stages may include a Cesium Lithium Borate (CLBO) crystal. In one embodiment, one or more of the second, third, and fourth stages includes an annealed CLBO crystal.

In another embodiment, a second stage can combine the fundamental frequency and the second harmonic frequency to generate a third harmonic frequency. A third stage can combine the second harmonic frequency and the third harmonic frequency to generate a fifth harmonic frequency. A fourth stage can combine the fundamental frequency and the fifth harmonic frequency to generate a sixth harmonic frequency of approximately 193.3 nm. The first and second stages can include a LBO crystal, the third stage can include beta-Barium Borate (BBO) crystal, and the fourth stage can include a CLBO crystal. In one embodiment, one or more of the second, third, and fourth stages can include an annealed LBO, BBO, and/or CLBO crystal.

In another embodiment, the laser can also include an optical amplifier for amplifying the fundamental frequency. This optical amplifier can include a doped photonic band-gap fiber optical amplifier, a Germania-doped Raman amplifier, or an undoped silica fiber Raman amplifier. The seed laser can include a Raman fiber laser, a low-power, ytterbium (Yb)-doped fiber laser, a photonic band-gap fiber laser, or an infra-red diode laser such as a diode laser using quantum dot technology.

The laser can also include beam splitters for providing the fundamental frequency to the first, third, and fourth stages. At least one mirror can be used for directing the fundamental frequency to an appropriate stage. In one embodiment, a set of mirrors can be used for directing unconsumed harmonics to appropriate stages.

The laser can also include an amplifier pump for pumping the optical amplifier. This amplifier pump can include an ytterbium-doped fiber laser operable at approximately 1070-1100 nm, or a neodymium-doped yttrium lithium fluoride laser operable between 1040-1070 nm.

A method of generating approximately 193 nm wavelength light is also described. This method includes generating a fundamental frequency of approximately 1160 nm. Portions of the fundamental frequency can be combined to generate a second harmonic frequency. Portions of the second harmonic frequency can be combined to generate a fourth harmonic frequency. The fundamental frequency and the fourth harmonic frequency can be combined to generate a fifth harmonic frequency. The fundamental frequency and the fifth harmonic frequency can be combined to generate a sixth harmonic frequency of approximately 193.3 nm.

Another method of generating approximately 193 nm wavelength light is also described. This method includes generating a fundamental frequency of approximately 1160 nm. Portions of the fundamental frequency can be combined to generate a second harmonic frequency. Portions of the second harmonic frequency can be combined with the fundamental frequency to generate a third harmonic frequency. The second harmonic frequency and the third harmonic frequency can be combined to generate a fifth harmonic frequency. The fundamental frequency and the fifth harmonic frequency can be combined to generate a sixth harmonic frequency of approximately 193.3 nm.

An optical inspection system for inspecting a surface of a photomask, reticle, or semiconductor wafer for defects is also described. This system can include a light source for emitting an incident light beam along an optical axis, the light source including a 6^{th} harmonic generator for generating 193 nm wavelength light. An optical system disposed along the optical axis and including a plurality of optical components is configured to separate the incident light beam into individual light beams, all of the individual light beams forming scanning spots at different locations on a surface of the photomask, reticle or semiconductor wafer. The scanning spots are configured to simultaneously scan the surface. A transmitted light detector arrangement can include transmitted light detectors that correspond to individual ones of a plurality of transmitted light beams caused by the intersection of the individual light beams with the surface of the reticle mask, or semiconductor wafer. The transmitted light detectors are arranged for sensing a light intensity of transmitted light. A reflected light detector arrangement can include reflected light detectors that correspond to individual ones of a plurality of reflected light beams caused by the intersection of the individual light beams with the surface of the reticle mask, or semiconductor wafer. The reflected light detectors are arranged for sensing a light intensity of reflected light.

An inspection system for inspecting a surface of a sample is also described. This inspection system includes an illumination subsystem configured to produce a plurality of channels of light, each channel of light produced having differing characteristics from at least one other channel of light energy. The illumination subsystem includes a 6^{th} harmonic generator for generating 193 nm wavelength light for at least one channel. Optics are configured to receive the plurality of channels of light and combine the plurality of channels of light energy into a spatially separated combined light beam and direct the spatially separated combined light beam toward the sample. A data acquisition subsystem includes at least one detector configured to detect reflected light from the sample. The data acquisition subsystem can be configured to separate the reflected light into a plurality of received channels corresponding to the plurality of channels of light.

A catadioptric inspection system is also described. This system includes an ultraviolet (UV) light source for generating UV light, a plurality of imaging sub-sections, and a folding mirror group. The UV light source includes a 6^{th} harmonic generator for generating 193 nm wavelength light. Each sub-section of the plurality of imaging sub-sections can includes a focusing lens group, a field lens group, a catadioptric lens group, and a zooming tube lens group.

The focusing lens group can include a plurality of lens elements disposed along an optical path of the system to focus the UV light at an intermediate image within the system. The focusing lens group can also simultaneously provide correction of monochromatic aberrations and chromatic variation of aberrations over a wavelength band including at least one wavelength in an ultraviolet range. The focusing lens group can further include a beam splitter positioned to receive the UV light.

The field lens group can have a net positive power aligned along the optical path proximate to the intermediate image. The field lens group can include a plurality of lens elements with different dispersions. The lens surfaces can be disposed at second predetermined positions and having curvatures selected to provide substantial correction of chromatic aberrations including at least secondary longitudinal color as well as primary and secondary lateral color of the system over the wavelength band.

The catadioptric lens group can include at least two reflective surfaces and at least one refractive surface disposed to form a real image of the intermediate image, such that, in combination with the focusing lens group, primary longitudinal color of the system is substantially corrected over the wavelength band. The zooming tube lens group, which can zoom or change magnification without changing its higher-order chromatic aberrations, can include lens surfaces disposed along one optical path of the system. The folding mirror group can be configured to allow linear zoom motion, thereby providing both fine zoom and wide range zoom.

A catadioptric imaging system with dark-field illumination is also described. This system can include an ultraviolet (UV) light source for generating UV light. This UV light source can include a 6^{th} harmonic generator for generating 193 nm wavelength light. Adaptation optics are also provided to control the illumination beam size and profile on the surface being inspected. An objective can include a catadioptric objective, a focusing lens group, and a zooming tube lens section in operative relation to each other. A prism can be provided for directing the UV light along the optical axis at normal incidence to a surface of a sample and directing specular reflections from surface features of the sample as well as reflections from optical surfaces of the objective along an optical path to an imaging plane.

An optical system for detecting anomalies of a sample is also described. This optical system includes a laser system for generating first and second beams. The laser system includes a light source, an annealed, frequency-conversion crystal, a housing, first beam shaping optics, and a harmonic separation block. The light source can include a 6^{th} harmonic generator for generating 193 nm wavelength light. The housing is provided to maintain an annealed condition of the crystal during standard operation at a low temperature. The first beam shaping optics can be configured to receive a beam from the light source and focus the beam to an elliptical cross section at a beam waist in or proximate to the crystal. The harmonic separation block receives an output from the crystal and generates therefrom the first and second beams and at least one undesired frequency beam.

First optics can direct the first beam of radiation along a first path onto a first spot on a surface of the sample. Second optics can direct the second beam of radiation along a second path onto a second spot on a surface of the sample. The first and second paths are at different angles of incidence to the surface of the sample. Collection optics can include a curved mirrored surface that receive scattered radiation from the first or the second spot on the sample surface and originate from the first or second beam and focus the scattered radiation to a first detector. The first detector provides a single output value in response to the radiation focused onto it by said curved mirrored surface. An instrument can be provided that causes relative motion between the first and second beams and the sample so that the spots are scanned across the surface of the sample.

A surface inspection apparatus is also described. This apparatus can include a laser system for generating a beam of radiation at 193 nm. This laser system can include a solid-state laser including a 6^{th} harmonic generator for generating the beam of radiation. An illumination system can be configured to focus the beam of radiation at a non-normal incidence angle relative to a surface to form an illumination line on the surface substantially in a plane of incidence of the focused beam. The plane of incidence is defined by the focused beam and a direction that is through the focused beam and normal to the surface.

A collection system can be configured to image the illumination line. In one embodiment, the collection system can include an imaging lens for collecting light scattered from a region of the surface comprising the illumination line. A focusing lens can be provided for focusing the collected light. A device including an array of light sensitive elements can also be provided. In this array, each light sensitive element of the array of light sensitive elements can be configured to detect a corresponding portion of a magnified image of the illumination line.

A pulse multiplier is also described. This pulse multiplier includes a laser system for generating an input laser pulse. The laser system can include a light source at approximately 1160 nm and a solid-state laser for receiving light from the light source and with a 6^{th} harmonic generator generating the input laser pulse at approximately 193 nm. A polarizing beam splitter can receive the input laser pulse. A wave plate can receive light from the polarized beam splitter and generate a first set of pulses and a second set of pulses, the first set of pulses having a different polarization than the second set of pulses. A set of mirrors can create a ring cavity including the polarizing beam splitter and the wave plate, wherein the polarizing beam splitter transmits the first set of pulses as an output of the pulse multiplier and reflects the second set of pulses into the ring cavity.

An inspection system incorporating a 193 nm laser and a coherence reducing subsystem comprising a dispersive element and/or an electro-optic modulator is also described.

### BRIEF DESCRIPTION OF THE DRAWINGS

FIG. 1 illustrates a block diagram of an exemplary solid-state laser for generating 193 nm light using a 6^{th} harmonic of a fundamental wavelength.

FIG. 2 illustrates a block diagram of another exemplary solid-state laser for generating 193 nm light using a 6^{th} harmonic of a fundamental wavelength.

FIG. 3 illustrates a block diagram of yet another exemplary solid-state laser for generating 193 nm light using a 6^{th} harmonic of a fundamental wavelength.

FIGS. 4A and 4B illustrate embodiments for generating and amplifying the fundamental laser light.

FIGS. 5 and 6 illustrate exemplary frequency conversion techniques for converting 1160 nm light to 193 nm light using a 6^{th} harmonic.

FIGS. 7 and 8 illustrate tables indicating various frequency conversion parameters for exemplary conversion techniques.

FIG. 9 illustrates a table indicating spectral and laser bandwidths for exemplary crystals for a solid-state laser.

FIG. 10 illustrates an exemplary inspection system including the solid-state 193 nm laser.

FIG. 11 illustrates an exemplary inspection system including multiple objectives and the solid-state 193 nm laser.

FIG. 12 illustrates the optics of an exemplary inspection system with adjustable magnification including the solid-state 193 nm laser.

FIG. 13 illustrates an exemplary inspection system with adjustable magnification (see, e.g. FIG. 12) including the solid-state 193 nm laser.

FIG. 14 illustrates an exemplary inspection system with dark-field and bright-field modes and including the solid-state 193 nm laser.

FIG. 15A illustrates a surface inspection apparatus including the solid-state 193 nm laser. FIG. 15B illustrates an exemplary array of collections for the surface inspection apparatus.

FIG. 16 illustrates an exemplary surface inspection system including the solid-state 193 nm laser.

FIG. 17 illustrates an inspection system including the solid-state 193 nm laser and using both normal and oblique illumination beams.

FIG. 18 illustrates an exemplary pulse multiplier that may be used in combination with the 193 nm laser and an inspection or metrology system.

FIG. 19 illustrates an exemplary coherence reducing subsystem that may be used in combination with the 193 nm laser and an inspection or metrology system.

### DETAILED DESCRIPTION OF THE DRAWINGS

An improved solid-state laser for generating 193 nm light is described. This laser uses the 6^{th} harmonic of a fundamental wavelength near 1160 nm to generate the 193 nm light. In the described embodiments, the laser mixes the 1160 nm fundamental wavelength with the 5^{th} harmonic, which is at a wavelength of approximately 232 nm. By proper selection of non-linear media, such mixing can be achieved by nearly non-critical phase matching, as described below. This mixing results in high conversion efficiency, good stability, and high reliability.

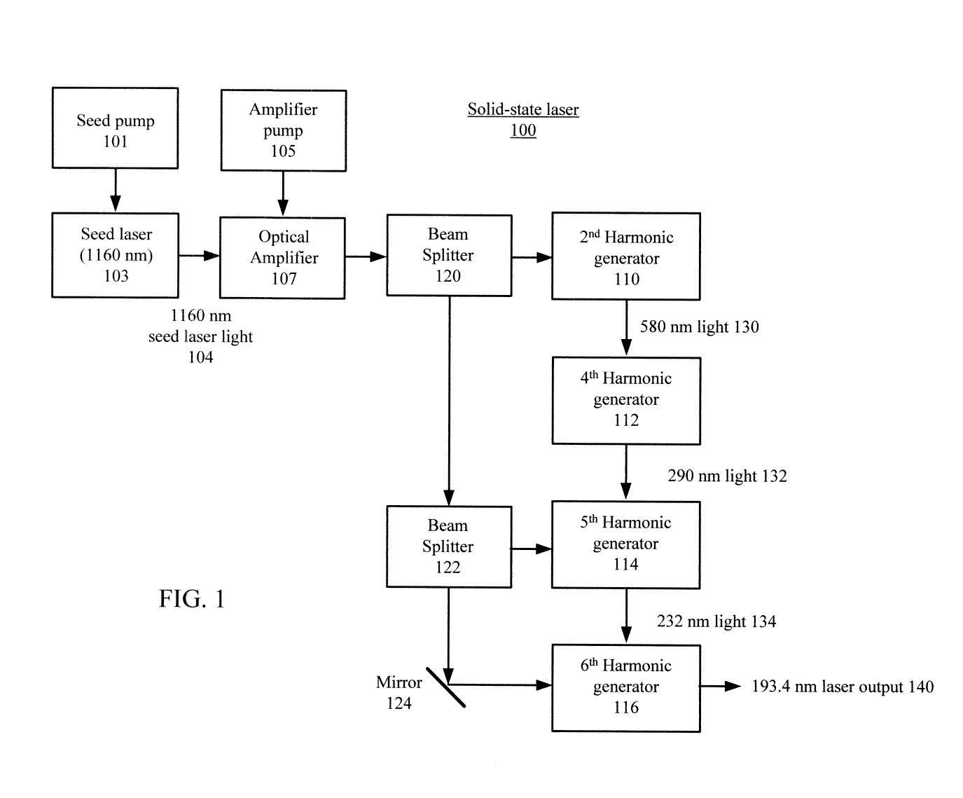

FIG. 1 illustrates a simplified block diagram of a solid-state laser 100 for generating 193 nm light. In this embodiment, laser 100 includes a seed laser 103 operating at a wavelength at or near 1160 nm, which generates a seed laser beam 104. In some preferred embodiments, seed laser 103 has a vacuum wavelength of approximately 1160.208 nm. Seed laser 103 may be optically pumped by a seed pump 101, which can comprise laser diodes or another laser. Seed laser 103 can be implemented by a Raman fiber laser, a low-power, ytterbium (Yb)-doped fiber laser, or an infra-red diode laser, such as an infra-red diode laser using quantum dot technology. Note that laser diodes do not need to be optically pumped, so in an embodiment using a laser diode as seed laser 103, seed pump 101 can be eliminated. Seed laser 103 should preferably be stabilized and have a narrow bandwidth. Techniques that can be used with seed laser 103 to control the wavelength and bandwidth include distributed feedback, or the use of wavelength selective devices such as fiber Bragg gratings, diffraction gratings or etalons. An advantage of this 193 nm laser over conventional 103 nm lasers is that seed laser 193 determines the overall stability and bandwidth of the output light. Stable, narrow-bandwidth lasers are generally easier to achieve at low power levels, such as levels of about 1 mW to a few hundred mW. Stabilizing the wavelength and narrowing the bandwidth of higher power or shorter wavelength lasers is more complex and expensive.

Seed laser light 104 can be amplified by an optical amplifier 107. Optical amplifier 107 can include a Yb-doped photonic band-gap fiber optical amplifier, a Yb-doped fiber optical amplifier, a Germania (Ge)-doped Raman amplifier, or an undoped silica fiber Raman amplifier. Because a narrow-band output from solid-state laser 100 may be desirable in some preferred embodiments, seed laser 103 may have a narrow bandwidth and may be stabilized. The bandwidth of the seed source should be narrow enough that the resulting 6^{th} harmonic will meet the bandwidth requirements. Note that because a Raman fiber laser tends naturally to have broad bandwidth, a Raman fiber amplifier may advantageously be seeded with a stable, narrow-bandwidth diode laser operating at, or near, 1160 nm.

The amplified laser light output by fiber amplifier 107, which is also at a wavelength near 1160 nm, is distributed to a 2^{nd} harmonic generator 110, a 5^{th} harmonic generator 114, and a 6^{th} harmonic generator 116. In solid-state laser 100, this distribution can be performed using beam splitters and/or mirrors. Specifically, beam splitter 120 can provide 1160 nm light to 2^{nd} harmonic generator 110 and beam splitter 122. Beam splitter 122 can directly provide 1160 nm light to 5^{th} harmonic generator 114, and indirectly provide 1160 nm light to 6^{th} harmonic generator 116 via a mirror 124.

2^{nd} harmonic generator 110 generates 580 nm light 130, which is provided to a 4^{th} harmonic generator 112. 4^{th} harmonic generator 112 uses the 580 nm light 130 to generate 290 nm light 132. 5^{th} harmonic generator 114 receives both the 1160 nm light (from beam splitter 122) and 290 nm light (from 4^{th} harmonic generator 112 ) to generate 232 nm light 134. 6^{th} harmonic generator 116 receives both the 1160 nm light (from beam splitter 122 via mirror 124) and 232 nm light (from 5^{th} harmonic generator 114) to generate 193.4 nm laser output 140. Some embodiments use multiple crystals in walkoff compensation geometry to improve the frequency conversion efficiency and beam profile in one or more critically phase-matched stages.

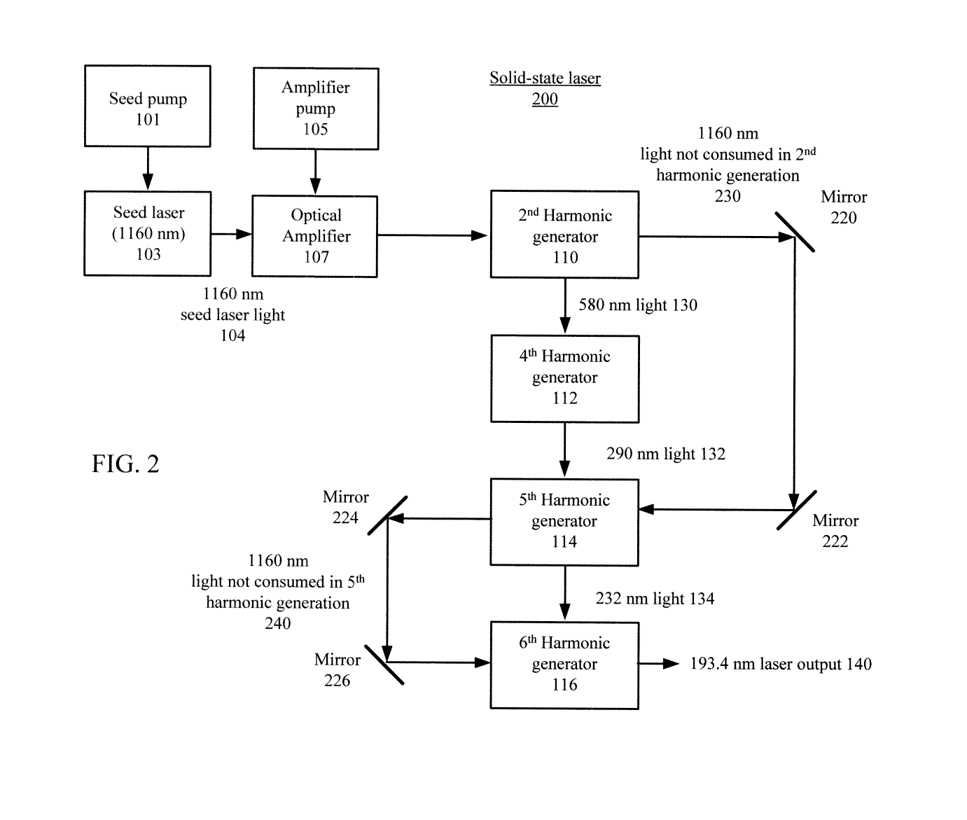

FIG. 2 illustrates a simplified block diagram of another solid-state laser 200 for generating 193 nm light. Note that identical components from the embodiments shown in FIGS. 1, 2, and 3 have the same labeling and therefore are not repeatedly described. In laser 200, the amplified output of fiber amplifier 107 is provided directly to 2^{nd} harmonic generator 110. Note that a harmonic generator does not completely consume its input light, which is exploited in laser 200. Specifically, the 1160 nm light not consumed by 2^{nd} harmonic generator 110 (i.e. an unconsumed fundamental 230) can be provided to 5^{th} harmonic generator 114 via mirrors 220 and 222. Similarly, the 1160 nm light not consumed by 5^{th} harmonic generator 114 (i.e. an unconsumed fundamental 240) can be provided to 6^{th} harmonic generator 116 via mirrors 224 and 226. Thus, in this configuration, beam splitters 120 and 122 (FIG. 1) can be eliminated.

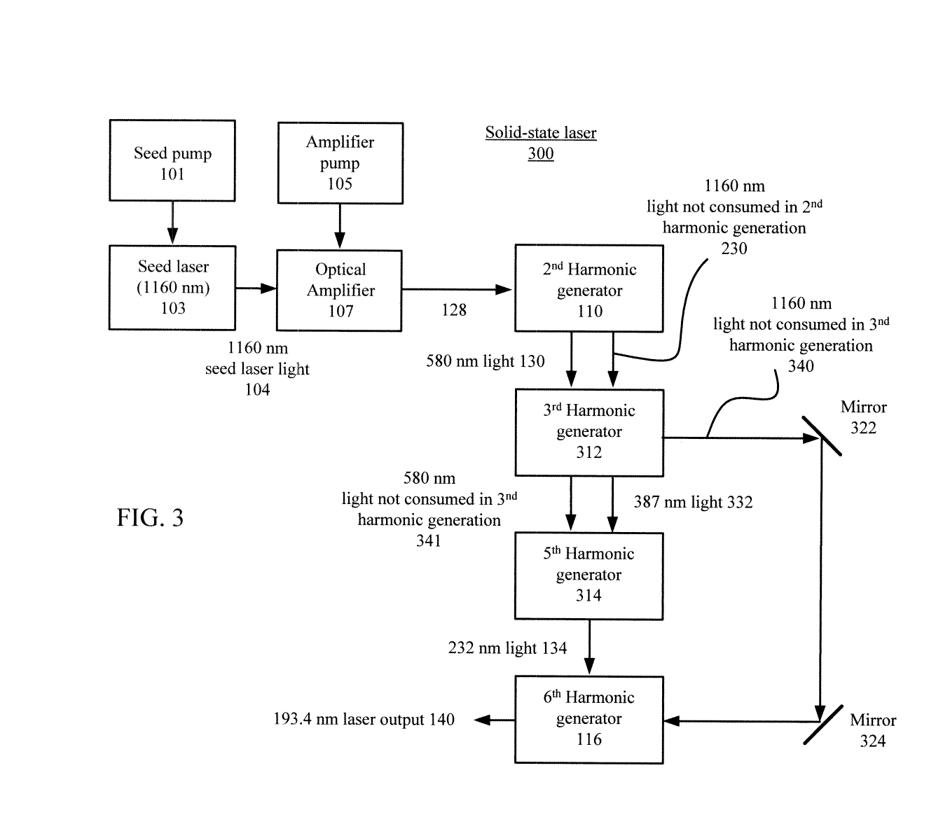

For some applications, it may be difficult to generate sufficient power in the 4^{th} harmonic (as shown in FIG. 2 for laser 200). In such cases, generation of the 3^{rd} harmonic may be preferred. FIG. 3 illustrates a solid-state laser 300 using the 3^{rd} harmonic, i.e. approximately 386.7 nm wavelength, to generate 193 nm light. In this embodiment, the 1160 nm light not consumed by 2^{nd} harmonic generator 110 (i.e. unconsumed fundamental 230) and the 580 nm light 130 generated by 2^{nd} harmonic generator 110 can be provided to a 3^{rd} harmonic generator 312. Additionally, the 1160 nm light not consumed by 3^{rd} harmonic generator 312 (i.e. an unconsumed fundamental 340) can be provided to 6^{th} harmonic generator 116 via mirrors 322 and 324. 6^{th} harmonic generator 116 can generate the 193 nm light by combining the 5^{th} harmonic (232 nm light 134) and the fundamental (1160 nm light). Some embodiments use multiple crystals in walkoff compensation geometry to improve the frequency conversion efficiency and beam profile in one or more critically phase-matched stages.

Generation and amplification of the fundamental may proceed substantially as in the previously described embodiments. In laser 300, the 3^{rd} harmonic is generated by mixing some of the fundamental (1160 nm) with the 2^{nd} harmonic (580 nm light 130). In one embodiment (not shown), the fundamental for generating the 3^{rd} harmonic can be taken directly from fiber amplifier 107. 5^{th} harmonic generator 314 can receive the 387 nm light 332 generated by 3^{rd} harmonic generator 312 as well as the 580 nm light not consumed by 3^{rd} harmonic generator 312. Thus, 5^{th} harmonic generator 314 generates the 5^{th} harmonic by combining 2^{nd} and 3^{rd} harmonics. 6^{th} harmonic generator 116 can generate the 193 nm light by combining the 5^{th} harmonic (232 nm light 134) and the fundamental (1160 nm light) in a similar manner to that described in lasers 100 and 200.

As known by those skilled in the art, more or fewer mirrors may be used to direct the light where needed. Lenses and curved mirrors may be used to focus the beam waist to a point inside or proximate to the non-linear crystals where appropriate. Prisms, gratings, or other diffractive optical elements may be used to separate the different wavelengths at the outputs of each harmonic generator module when needed. Appropriately coated mirrors may be used to combine the different wavelengths at the input to the harmonic generators as appropriate. Beam splitters or coated mirrors may be used as appropriate to separate wavelengths or to divide one wavelength into two beams.

In some embodiments, to generate sufficient power at the fundamental 1160 nm wavelength, two or more amplifiers may be used, instead of splitting the output from one amplifier or reusing the unconsumed fundamental from multiple stages. Note that if two or more amplifiers are used, then one seed laser should preferably be used to seed all the amplifiers so that all amplifiers are synchronized.

Note that optical amplifier 107 also receives pumped light from an amplifier pump 105. In one embodiment, a laser-diode pump Yb-doped fiber laser can be used to pump light to fiber amplifier 107. In some embodiments, the pump wavelength can be approximately 1070 nm to approximately 1090 nm. Using a pump wavelength longer than 1064 nm can be advantageous because it ensures no pumping of the energy levels of the Yb-doped fiber that can generate 1030 nm or 1064 nm radiation. One of the challenges of making Yb-doped fibers amplify 1160 nm wavelength light is amplified spontaneous emission (ASE) at wavelengths near 1030 nm and/or 1064 nm, resulting in part of the energy being deposited into undesired wavelengths and, therefore, reducing of the output at 1160 nm. Using a pump wavelength longer than either of these wavelengths ensures insufficient gain at either wavelength even if spontaneous emission occurs. In another embodiment, amplifier pump 105 may include a solid-state laser to provide pumped light to fiber amplifier 107.

Other techniques are also available to reduce the impact of ASE on the gain at 1160 nm. Exemplary Yb-doped photonic bandgap fiber amplifiers to implement fiber amplifier 107 are described by A. Shirakawa et al. in “High-power Yb-doped photonic bandgap fiber amplifier at 1150-200 nm”, Optics Express 17 (#2), pages 447-454 (2009). Alternatively, a heated Yb-doped fiber pumped by a 1090 nm Yb-doped fiber laser, such as that described by M. P. Kalita et al. in “Multi-watts narrow-linewidth all fiber Yb-doped laser operating at 1179 nm” in Optics Express 18 (#6), pages 5920-5925 (2010) may be used. Yet another technique to reduce the impact of ASE is to use multiple amplifier stages with spectral filtering in between each to reduce the impact of ASE. In this case optical amplifier 107 will consist of two or more amplifiers. It is also possible to use these approaches in combination to achieve the desired gain at 1160 nm.

As known by those skilled in the art, the operating wavelength of these amplifiers can be easily modified to be close to 1160 nm by appropriate choice of wavelength selective elements, such as fiber Bragg gratings, free space gratings, and coatings. Other alternative amplifiers include those based on Bi-doped fibers, which are described by B. M. Dianov et al. in “Bi-doped fiber lasers: new type of high-power radiation sources” in 2007 CLEO and S. Yoo et al. in “Excited state absorption measurement in bismth-doped silicate fibers for use in 1160 nm fiber laser” in 3rd EPS-QEOD Europhoton Conference, Paris, France, 31Aug.-5 Sep. 2008. Yet other alternative amplifiers include those based on LiF color-center lasers as described, for example, in the Ter-Mikirtychev et al. in “Tunable LiF:F, color center laser with an intracavity integrated optic output coupler” in Journal of Lightwave Technology, 14 (10), 2353-2355 (1996) or Digital Object Identifier: 10.1109/50.541228.

In some embodiments, 2^{nd} harmonic generator 110 can include an LBO crystal, which is substantially non-critically phase-matched at a temperature of about 53° C. Note that non-critical phase matching (also called temperature phase matching) is one technique for obtaining phase matching of a non-linear process. Specifically, the interacting beams are aligned such that they propagate along an axis of the non-linear crystal. The phase mismatch is minimized by adjusting the crystal temperature so that the phase velocities of the interacting beams are equal. The term “non-critical phase matching” means that there is no walkoff between the propagation of the energy in the different wavelengths. 4^{th} and 5^{th} harmonic generators 112 and 114 can include CLBO, BBO, LBO, or another type of non-linear crystal to provide critical phase matching. 3^{rd} harmonic generator 312 can include a CLBO, BBO, LBO, or other non-linear crystal. 6^{th} harmonic generator 116 can include a CLBO crystal, which is nearly non-critically phase matched at an angle of about 80° resulting in a high D_{eff} (>1 pm/V) and a low walk-off angle (<20 mrad). Note that because there is minimal beam walk-off, a longer conversion crystal can be used, and alignment tolerances are greater compared with phase matching far from the non-critical regime.

5^{th} and/or 6^{th} harmonic generators may use some, or all, of the methods and systems disclosed in U.S. patent application Ser. No. 13/412,564, entitled “Laser With High Quality, Stable Output Beam, And Long Life High Conversion Efficiency Non-Linear Crystal”, filed Mar. 5, 2012 and incorporated by reference herein. Any of the harmonic generators used in lasers 100, 200, and 300 may advantageously use hydrogen-annealed non-linear crystals. Such crystals may be processed as described in KLA-Tencor patent application Ser. No. 13/488,635 entitled “Hydrogen Passivation of Nonlinear Optical Crystals” by Chuang et al. filed on Jun. 1, 2012, which is incorporated by reference herein.

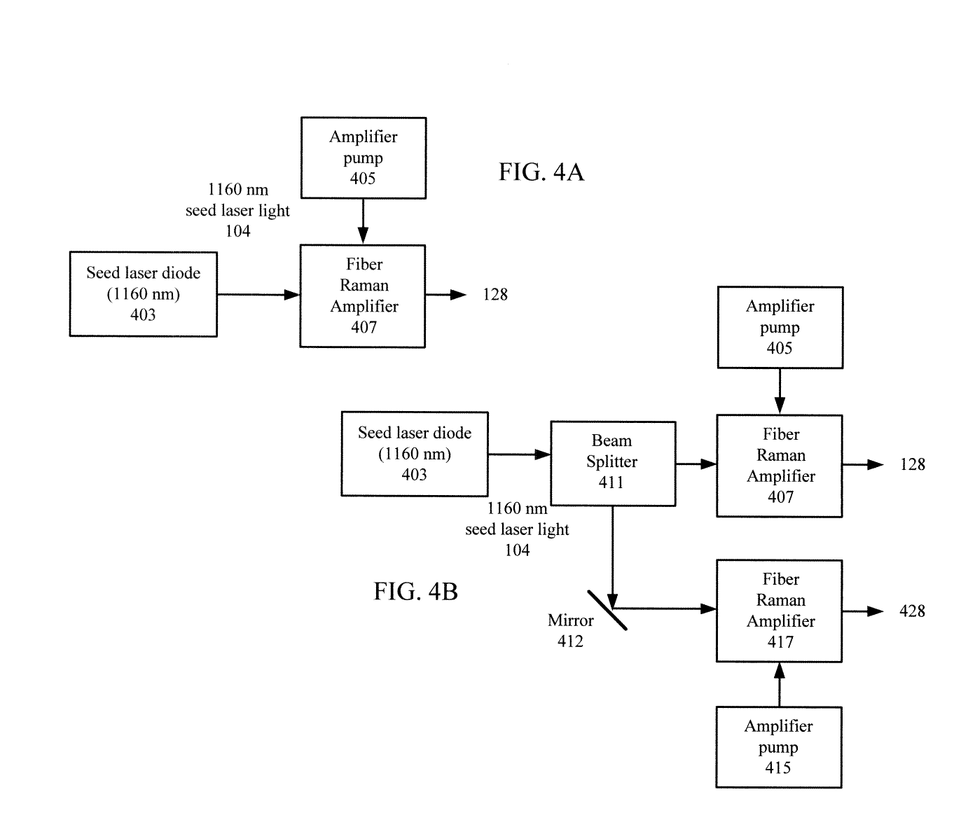

FIG. 4A illustrates one embodiment for generating and amplifying the fundamental laser light. In this embodiment, a stabilized, narrow-band laser diode 403 (such as those discussed above) generates seed laser light 104 at a wavelength close to 1160 nm. Seed laser light 104 is received by a fiber Raman amplifier 407 that amplifies the light to a higher power level. In some preferred embodiments, fiber Raman amplifier 407 can include a germania (or germanium)-doped silica fiber. In other preferred embodiments, the fiber is an undoped, silica fiber. Amplifier pump 405 is a laser that pumps fiber Raman amplifier 407. In some preferred embodiments, the pump wavelength is within 20-30 nm of 1104 nm (such as between about 1074 and 1134 nm) because that corresponds to the most efficient gain at 1160 nm for silica-based fibers (the Raman shift being centered at approximately 440 cm⁻¹). In some preferred embodiments, amplifier pump 405 can be implemented using a Yb-doped fiber laser operating at approximately 1100 nm in wavelength. In other preferred embodiments, the second-order Raman shift centered near 880 cm⁻¹ can be used with a pump wavelength of approximately 1053 nm (such as a wavelength between about 1040 and 1070 nm) from a Yb-doped fiber laser or a Nd:YLF (neodymium-doped yttrium lithium fluoride) laser.

FIG. 4B illustrates another embodiment for generating and amplifying the fundamental laser light. Note that when multiple harmonic generators (i.e. frequency conversion stages) are configured to receive the fundamental laser wavelength, and depending on the output power required near 193 nm in wavelength, more fundamental laser light may be required than can be generated in a single Raman amplifier without problems (such as self-phase modulation, cross-phase modulation, or heating) that degrade the performance or increase the bandwidth of the output. In such cases, multiple Raman amplifiers may be used to generate multiple fundamental laser outputs, which are directed to their respective harmonic generators. For example, two Raman amplifiers 407 and 417 may be used to respectively generate two fundamental laser outputs 128 and 428, which are directed to different harmonic generators (e.g. harmonic generators 110 and 114 (FIG. 1, when beam splitters are not used). Fiber Raman amplifier 417 can be substantially identical to fiber Raman amplifier 407. An amplifier pump 415 for fiber Raman amplifier 417 can be substantially identical to amplifier pump 405. Note that a same seed laser, in this case seed laser diode 403, should be used to seed both fiber Raman amplifiers 407 and 417 to ensure that outputs 128 and 428 are synchronized and have a substantially constant phase relationship. A beam splitter 411 and a mirror 412 respectively divide the seed laser output 104 and direct a fraction of it to fiber Raman amplifier 417.

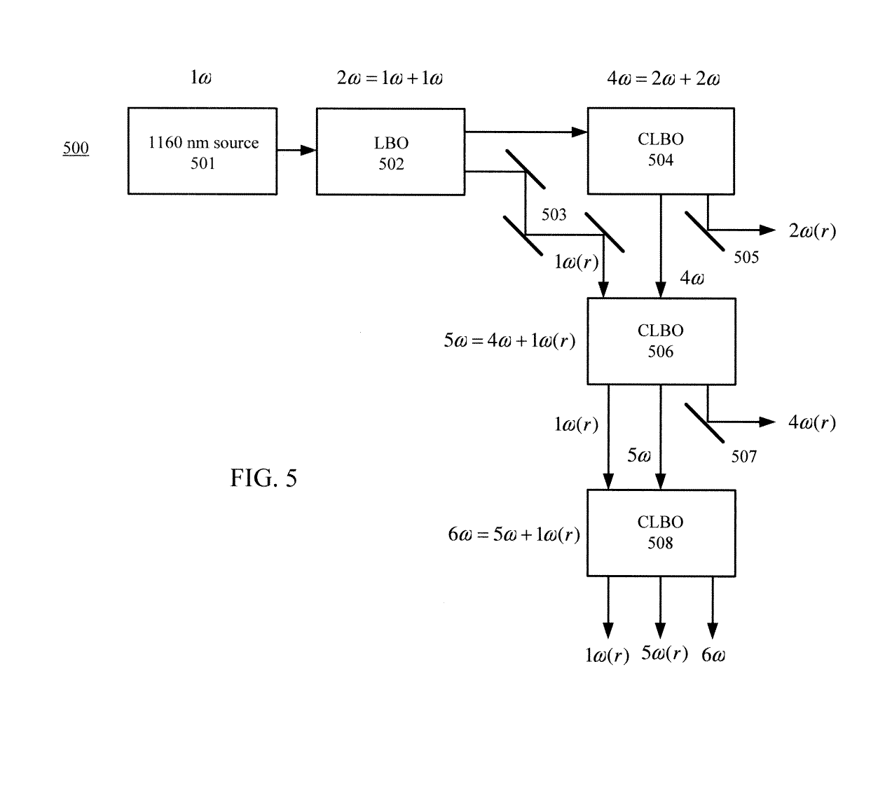

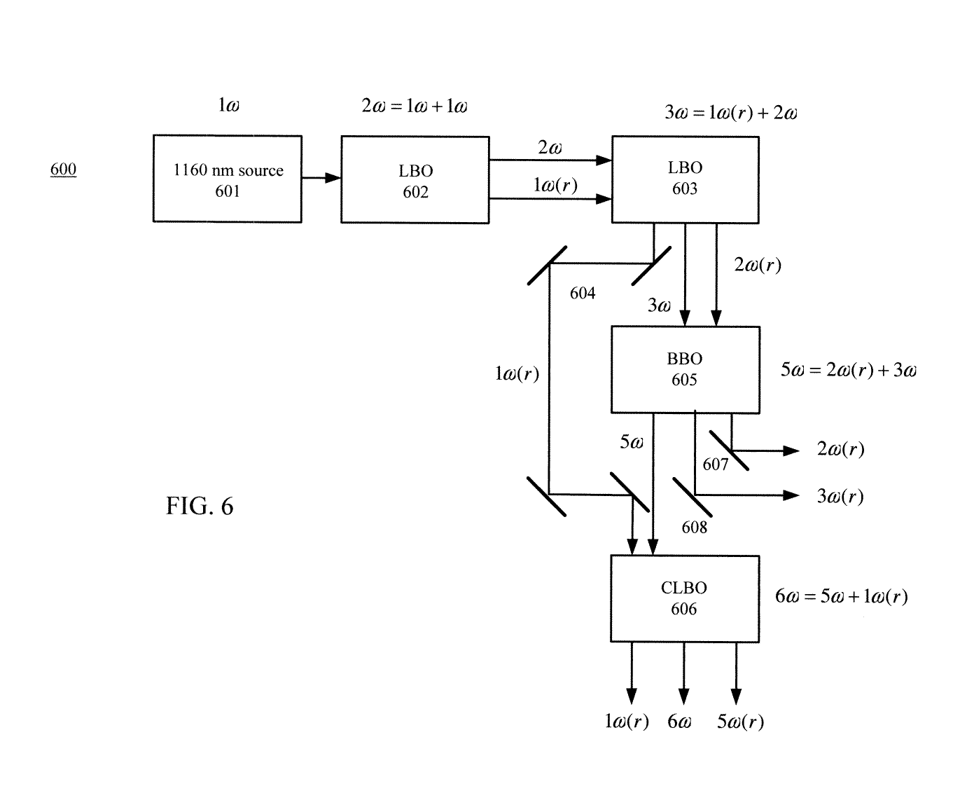

FIGS. 5 and 6 illustrate exemplary frequency conversion techniques for generating the 6^{th} harmonic frequency. For ease of reference when describing those techniques, ω refers to a specific harmonic (e.g. 2ω) refers to the second harmonic) and ω(r) refers to a residual of a specific harmonic.

In the frequency conversion technique 500 shown in FIG. 5, a 1160 nm source 501 generates the fundamental, i.e. the first harmonic 1ω. An LBO crystal 502 receives 1ω and uses it to generate 2ω (i.e. 2ω=1ω+1ω). A CLBO crystal 504 receives 2ω(and uses it to generate 4ω (i.e. 4ω=2ω+2ω). CLBO crystal 506 receives 4ω and the residual 1ω(r) (from LBO crystal 502 via mirror set 503) and uses those harmonics to generate 5ω (i.e. 5ω=4ω+1ω(r)). (Note that neither CLBO nor LBO can phase match 4ω+2ω. Therefore, 5ω and 6ω are successively generated instead.) CLBO crystal 508 receives 5ω and 1ω(r) (both from CLBO crystal 506 ) and uses those harmonics to generate 6ω (i.e. 6ω=5ω+1ω). Note that CLBO crystal 508 can also output the residual first and fifth harmonics 1ω(r) and 5ω(r), which can be used in other processes not related to the present invention. Further note that mirrors 505 and 507 can respectively direct the residual second harmonic 2ω(r) and the residual fourth harmonic 4ω(r) to such other processes as needed.

In the frequency conversion technique 600 shown in FIG. 6, a 1160 nm source 601 generates the fundamental, i.e. the first harmonic 1ω. An LBO crystal 602 receives 1ω and uses it to generate 2ω (i.e. 2ω=1ω+1ω). An LBO crystal 603 receives 2ω and the residual 1ω(r) and uses it to generate 3ω (i.e. 3ω=1ω(r)+2ω). A BBO crystal 605 receives 3ω and the residual 2ω(r) (both from LBO crystal 603) and uses those harmonics to generate 5ω (i.e. 5ω=2ω+3ω). (Note that CLBO cannot phase match 2ω+3ω. Therefore, a BBO crystal can be used instead.) A CLBO crystal 606 receives 5ω and 1ω(r) (from LBO crystal 603 via mirror set 604) and uses those harmonics to generate 6ω (i.e. 6ω=5ω+1ω(r)). Note that CLBO crystal 606 can also output the residual first and fifth harmonics 1ω(r) and 5ω(r), which can be used in other processes not related to the present invention. Further note that mirrors 607 and 608 can respectively direct the residual second harmonic 2ω(r) and the residual third harmonic 3ω(r) to such other processes as needed.

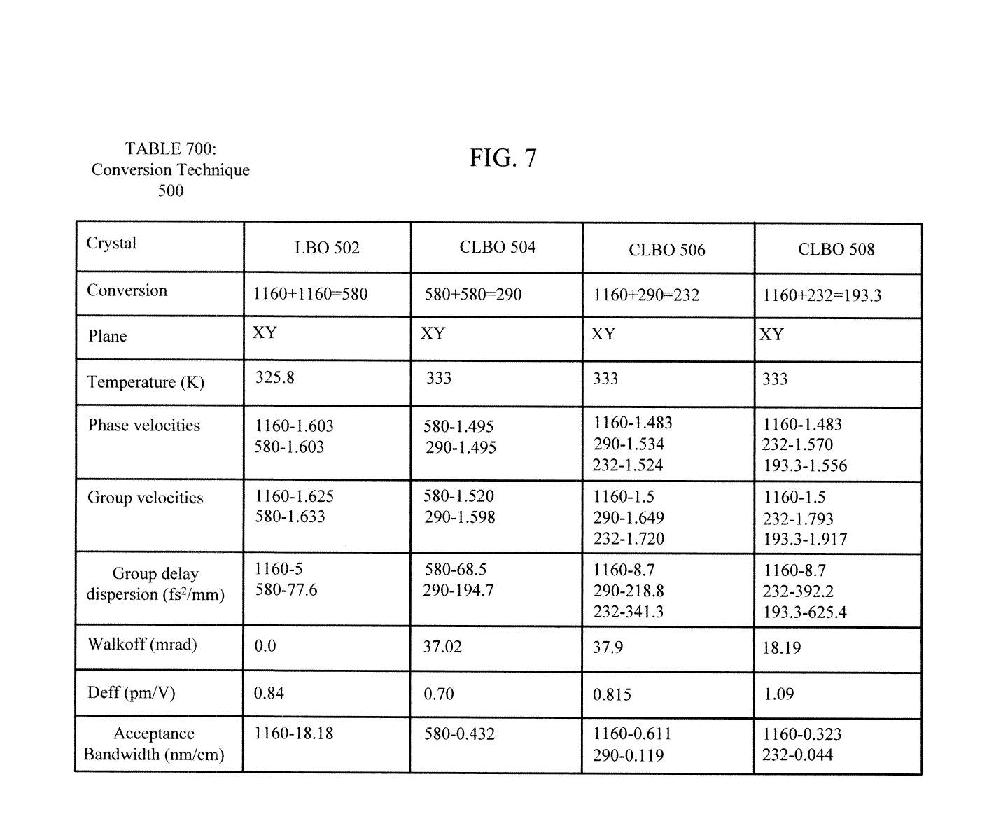

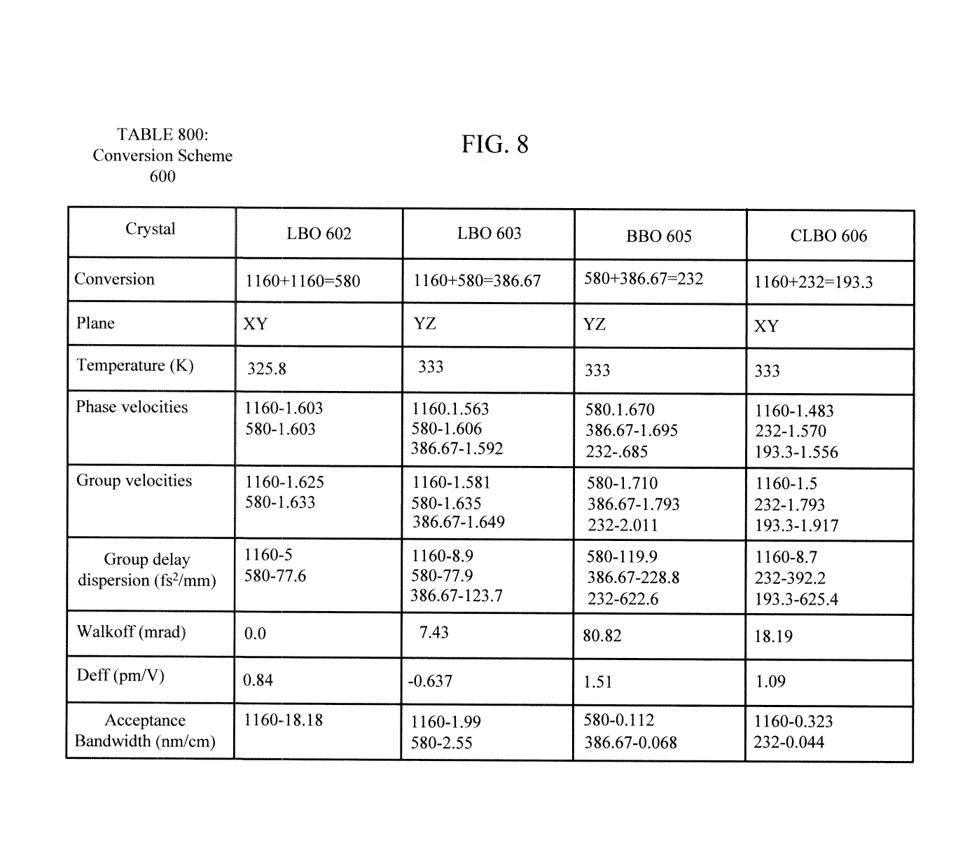

FIG. 7 illustrates a table 700 that provides additional details regarding frequency conversion technique 500 (FIG. 5). FIG. 8 illustrates a table 800 that provides additional details regarding frequency conversion technique 600 (FIG. 6).

Note that these techniques and additional details are exemplary and may vary based on implementation and/or system constraints. Techniques 500 and 600 as well as tables 700 and 800 show that there are potentially multiple ways to generate the 6^{th} harmonic of light substantially near 1160 nm in wavelength, and there is the potential for good operating margins for each frequency conversion stage. One of ordinary skill in the relevant arts will appreciate that different, but substantially equivalent frequency conversion techniques may be used without departing from the scope of the invention. Some embodiments use multiple crystals in a walkoff compensation geometry to improve the frequency conversion efficiency and beam profile in any critically phase matched stage.

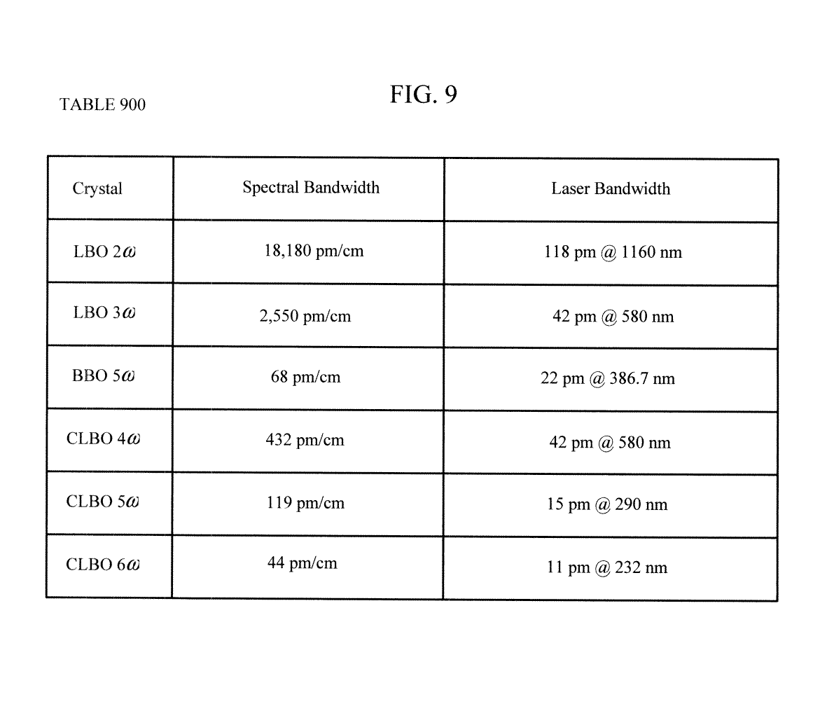

FIG. 9 illustrates a table 900 that shows for each type of crystal generating a specific harmonic, the frequency conversion bandwidth is much greater than the spectral bandwidth of interest for each conversion stage (which refers to a harmonic generator (i.e. crystal) that generates a harmonic wavelength). This bandwidth differential means that the effects of the spectral bandwidth on the conversion efficiency calculation can be advantageously ignored. Note that the pulse is assumed to have a uniform spectrum in time. This assumption is valid because relatively short fibers (approximately 1 m) are used.

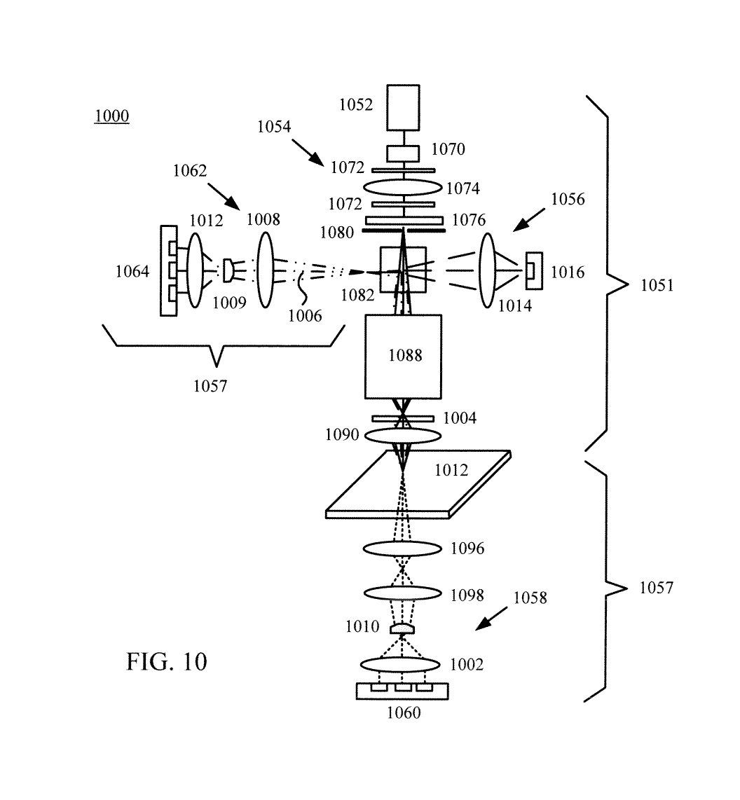

FIGS. 10-17 illustrate systems that can include the above-described solid-state 193 nm lasers using the 6^{th} harmonic. These systems can be used in photomask, reticle, or wafer inspection applications.

FIG. 10 illustrates an exemplary optical inspection system 1000 for inspecting the surface of a substrate 1012. System 1000 generally includes a first optical arrangement 1051 and a second optical arrangement 1057. As shown, first optical arrangement 1051 includes at least a light source 1052, inspection optics 1054, and reference optics 1056, while the second optical arrangement 1057 includes at least transmitted light optics 1058, transmitted light detectors 1060, reflected light optics 1062, and reflected light detectors 1064. In one preferred configuration, light source 1052 includes one of the above-described solid-state 193 nm lasers.

The light source 1052 is configured to emit a light beam that passes through an acousto-optic device 1070, which is arranged for deflecting and focusing the light beam. Acousto-optic device 1070 may include a pair of acousto-optic elements, e.g. an acousto-optic pre-scanner and an acousto-optic scanner, which deflect the light beam in the Y-direction and focus it in the Z-direction. By way of example, most acousto-optic devices operate by sending an RF signal to quartz or a crystal such as TeO₂. This RF signal causes a sound wave to travel through the crystal. Because of the travelling sound wave, the crystal becomes asymmetric, which causes the index of refraction to change throughout the crystal. This change causes incident beams to form a focused travelling spot which is deflected in an oscillatory fashion.

When the light beam emerges from acousto-optic device 1070, it then passes through a pair of quarter wave plates 1072 and a relay lens 1074. Relay lens 1074 is arranged to collimate the light beam. The collimated light beam then continues on its path until it reaches a diffraction grating 1076. Diffraction grating 1076 is arranged for flaring out the light beam, and more particularly for separating the light beam into three distinct beams, which are spatially distinguishable from one another (i.e. spatially distinct). In most cases, the spatially distinct beams are also arranged to be equally spaced apart and have substantially equal light intensities.

Upon leaving the diffraction grating 1076, the three beams pass through an aperture 1080 and then continue until they reach a beam splitter cube 1082. Beam splitter cube 1082 (in combination with the quarter wave plates 1072) is arranged to divide the beams into two paths, i.e. one directed downward in FIG. 10 and the other directed to the right. The path directed downward is used to distribute a first light portion of the beams to substrate 1012, whereas the path directed to the right is used to distribute a second light portion of the beams to reference optics 1056. In most embodiments, most of the light is distributed to substrate 1012 and a small percentage of the light is distributed to reference optics 1056, although the percentage ratios may vary according to the specific design of each optical inspection system. In one embodiment, reference optics 1056 can include a reference collection lens 1014 and a reference detector 1016. Reference collection lens 1014 is arranged to collect and direct the portion of the beams on reference detector 1016, which is arranged to measure the intensity of the light. Reference optics are generally well known in the art and for the sake of brevity will not be discussed in detail.

The three beams directed downward from beam splitter 1082 are received by a telescope 1088, which includes several lens elements that redirect and expand the light. In one embodiment, telescope 1088 is part of a telescope system that includes a plurality of telescopes rotating on a turret. For example, three telescopes may be used. The purpose of these telescopes is to vary the size of the scanning spot on the substrate and thereby allow selection of the minimum detectable defect size. More particularly, each of the telescopes generally represents a different pixel size. As such, one telescope may generate a larger spot size making the inspection faster and less sensitive (e.g., low resolution), while another telescope may generate a smaller spot size making inspection slower and more sensitive (e.g., high resolution).

From telescope 1088, the three beams pass through an objective lens 1090, which is arranged for focusing the beams onto the surface of substrate 1012. As the beams intersect the surface as three distinct spots, both reflected light beams and transmitted light beams may be generated. The transmitted light beams pass through substrate 1012, while the reflected light beams reflect off the surface. By way of example, the reflected light beams may reflect off of opaque surfaces of the substrate, and the transmitted light beams may transmit through transparent areas of the substrate. The transmitted light beams are collected by transmitted light optics 1058 and the reflected light beams are collected by reflected light optics 1062.

With regards to transmitted light optics 1058, the transmitted light beams, after passing through substrate 1012, are collected by a first transmitted lens 1096 and focused with the aid of a spherical aberration corrector lens 1098 onto a transmitted prism 1010. Prism 1010 can be configured to have a facet for each of the transmitted light beams that are arranged for repositioning and bending the transmitted light beams. In most cases, prism 1010 is used to separate the beams so that they each fall on a single detector in transmitted light detector arrangement 1060 (shown as having three distinct detectors). Accordingly, when the beams leave prism 1010, they pass through a second transmitted lens 1002, which individually focuses each of the separated beams onto one of the three detectors, each of which is arranged for measuring the intensity of the transmitted light.

With regards to reflected light optics 1062, the reflected light beams after reflecting off of substrate 1012 are collected by objective lens 1090, which then directs the beams towards telescope 1088. Before reaching telescope 1088, the beams also pass through a quarter wave plate 1004. In general terms, objective lens 1090 and telescope 1088 manipulate the collected beams in a manner that is optically reverse in relation to how the incident beams are manipulated. That is, objective lens 1090 re-collimates the beams, and telescope 1088 reduces their size. When the beams leave telescope 1088, they continue (backwards) until they reach beam splitter cube 1082. Beam splitter 1082 is arranged to work with quarter wave-plate 1004 to direct the beams onto a central path 1006.

The beams continuing on path 1006 are then collected by a first reflected lens 1008, which focuses each of the beams onto a reflected prism 1009, which includes a facet for each of the reflected light beams. Reflected prism 1009 is arranged for repositioning and bending the reflected light beams. Similar to the transmitted prism 1010, the reflected prism 1009 is used to separate the beams so that they each fall on a single detector in the reflected light detector arrangement 1064. As shown, reflected light detector arrangement 1064 includes three individually distinct detectors. When the beams leave reflected prism 1009, they pass through a second reflected lens 1012, which individually focuses each of the separated beams onto one of these detectors, each of which is arranged for measuring the intensity of the reflected light.

There are multiple inspection modes that can be facilitated by the aforementioned optical assembly 1050. By way of example, the optical assembly 1050 can facilitate a transmitted light inspection mode, a reflected light inspection mode, and a simultaneous inspection mode. With regards to transmitted light inspection mode, transmission mode detection is typically used for defect detection on substrates such as conventional optical masks having transparent areas and opaque areas. As the light beams scan the mask (or substrate 1012), the light penetrates the mask at transparent points and is detected by the transmitted light detectors 1060, which are located behind the mask and which measure the intensity of each of the light beams collected by transmitted light optics 1058 including first transmitted lens 1096, second transmitted lens 1002, spherical aberration lens 1098, and prism 1010.

With regards to reflected light inspection mode, reflected light inspection can be performed on transparent or opaque substrates that contain image information in the form of chromium, developed photoresist or other features. Light reflected by the substrate 1012 passes backwards along the same optical path as inspection optics 1054, but is then diverted by a polarizing beam splitter 1082 into detectors 1064. More particularly, first reflected lens 1008, prism 1009, and second reflected lens 1012 project the light from the diverted light beams onto detectors 1064. Reflected light inspection may also be used to detect contamination on top of opaque substrate surfaces.

With regards to simultaneous inspection mode, both transmitted light and reflected light are utilized to determine the existence and/or type of a defect. The two measured values of the system are the intensity of the light beams transmitted through substrate 1012 as sensed by transmitted light detectors 1060 and the intensity of the reflected light beams as detected by reflected light detectors 1064. Those two measured values can then be processed to determine the type of defect, if any, at a corresponding point on substrate 1012.

More particularly, simultaneous transmitted and reflected detection can disclose the existence of an opaque defect sensed by the transmitted detectors while the output of the reflected detectors can be used to disclose the type of defect. As an example, either a chrome dot or a particle on a substrate may both result in a low transmitted light indication from the transmission detectors, but a reflective chrome defect may result in a high reflected light indication and a particle may result in a lower reflected light indication from the same reflected light detectors. Accordingly, by using both reflected and transmitted detection one may locate a particle on top of chrome geometry which could not be done if only the reflected or transmitted characteristics of the defect were examined. In addition, one may determine signatures for certain types of defects, such as the ratio of their reflected and transmitted light intensities. This information can then be used to automatically classify defects. U.S. Pat. No. 5,563,702, which issued on Apr. 1, 2008 and is incorporated by reference herein, describes additional details regarding system 1000.

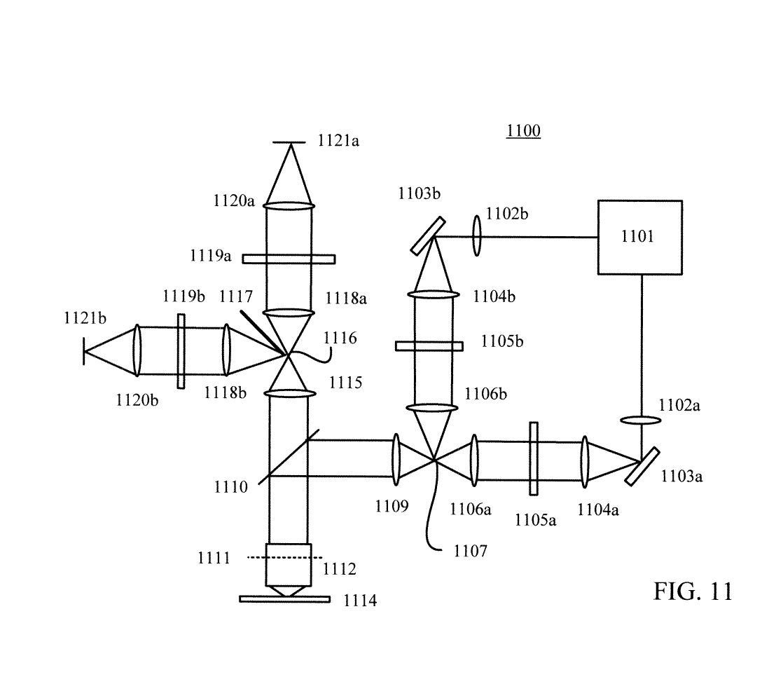

FIG. 11 illustrates an exemplary inspection system 1100 including multiple objectives and one of the above-described solid-state 193 nm lasers. In system 1100, illumination from a laser source 1101 is sent to multiple sections of the illumination subsystem. A first section of the illumination subsystem includes elements 1102a through 1106a. Lens 1102a focuses light from laser 1101. Light from lens 1102a then reflects from mirror 1103a. Mirror 1103a is placed at this location for the purposes of illustration, and may be positioned elsewhere. Light from mirror 1103a is then collected by lens 1104a, which forms illumination pupil plane 1105a. An aperture, filter, or other device to modify the light may be placed in pupil plane 1105a depending on the requirements of the inspection mode. Light from pupil plane 1105a then passes through lens 1106a and forms illumination field plane 1107.

A second section of the illumination subsystem includes elements 1102b through 1106b. Lens 1102b focuses light from laser 1101. Light from lens 1102b then reflects from mirror 1103b. Light from mirror 1103b is then collected by lens 1104b which forms illumination pupil plane 1105b. An aperture, filter, or other device to modify the light may be placed in pupil plane 1105b depending on the requirements of the inspection mode. Light from pupil plane 305b then passes through lens 1106b and forms illumination field plane 1107. The second section is then redirected by mirror or reflective surface 1108. Illumination field light energy at illumination field plane 1107 is thus comprised of the combined illumination sections.

Field plane light is then collected by lens 1109 before reflecting of beamsplitter 1110. Lenses 1106a and 1109 form an image of first illumination pupil plane 1105a at objective pupil plane 1111. Likewise, lenses 1106b and 1109 form an image of second illumination pupil plane 1105b at objective pupil plane 1111. Objective 1112 or 1113 then take pupil light 1111 and form an image of illumination field 1107 at the sample 1114. Objectives 1112 and 1113 can be positioned in proximity to sample 1114. Sample 1114 can move on a stage (not shown), which positions the sample in the desired location. Light reflected and scattered from the sample 1114 is collected by the high NA catadioptric objective 1112 or 1113. After forming a reflected light pupil at point 1111, light energy passes beamsplitter 1110 and lens 1115 before forming an internal field 1116 in the imaging subsystem. This internal imaging field is an image of sample 1114 and correspondingly illumination field 1107. This field may be spatially separated into multiple fields corresponding to the illumination fields. Each of these fields can support a separate imaging mode.

One of these fields can be redirected using mirror 1117. The redirected light then passes through lens 1118b before forming another imaging pupil 1119b. This imaging pupil is an image of pupil 1111 and correspondingly illumination pupil 1105b. An aperture, filter, or other device to modify the light may be placed in pupil plane 1119b depending on the requirements of the inspection mode. Light from pupil plane 1119b then passes through lens 1120b and forms an image on sensor 1121b. In a similar manner, light passing by mirror or reflective surface 1117 is collected by lens 1118a and forms imaging pupil 1119a. Light from imaging pupil 1119a is then collected by lens 1120a before forming an image on detector 1121a. Light imaged on detector 1121a can be used for a different imaging mode from the light imaged on sensor 1121b.

The illumination subsystem employed in system 1100 is composed of laser source 1101, collection optics 1102-1104, beam shaping components placed in proximity to a pupil plane 1105, and relay optics 1106 and 1109. An internal field plane 1105 is located between lenses 1106 and 1109. In one preferred configuration, laser source 1101 can include one of the above-described solid-state 193 nm lasers.

With respect to laser source 1101, while illustrated as a single uniform block having two points or angles of transmission, in reality this represents a laser source able to provide two channels of illumination, for example a first channel of light energy such as laser light energy at a first frequency (the 6^{th} harmonic) which passes through elements 1102a-1106a, and a second channel of light energy such as laser light energy at a second frequency (e.g. the 3^{rd} harmonic) which passes through elements 1102b-1106b. Different light energy modes may be employed, such as bright field energy in one channel and a dark field mode in the other channel.

While light energy from laser source 1101 is shown to be emitted 90 degrees apart, and the elements 1102a-1106a and 1102b-1106b are oriented at 90 degree angles, in reality light may be emitted at various orientations, not necessarily in two dimensions, and the components may be oriented differently than as shown. FIG. 11 is therefore simply a representation of the components employed and the angles or distances shown are not to scale nor specifically required for the design.

Elements placed in proximity to pupil plane 1105 may be employed in the current system using the concept of aperture shaping. Using this design, uniform illumination or near uniform illumination may be realized, as well as individual point illumination, ring illumination, quadrapole illumination, or other desirable patterns.

Various implementations for the objectives may be employed in a general imaging subsystem. A single fixed objective may be used. The single objective may support all the desired imaging and inspection modes. Such a design is achievable if the imaging system supports a relatively large field size and relatively high numerical aperture. Numerical aperture can be reduced to a desired value by using internal apertures placed at the pupil planes 1105a, 1105b, 1119a, and 1119b.

Multiple objectives may also be used as shown in FIG. 11. Two objectives 1112 and 1113 are shown in this figure, but any number is possible. Each objective in such a design may be optimized for each wavelength produced by laser source 1101. These objectives 1112 and 1113 can either have fixed positions or be moved into position in proximity to the sample 1114. To move multiple objectives in proximity to the sample, rotary turrets may be used as are common on standard microscopes. Other designs for moving objectives in proximity of a sample are available, including but not limited to translating the objectives laterally on a stage, and translating the objectives on an arc using a goniometer. In addition, any combination of fixed objectives and multiple objectives on a turret can be achieved in accordance with the present system.

The maximum numerical apertures of the current embodiments approach or exceed 0.97, but may in certain instances be higher. The wide range of illumination and collection angles possible with this high NA catadioptric imaging system, combined with its large field size allows the system to simultaneously support multiple inspection modes. As may be appreciated from the previous paragraphs, multiple imaging modes can be implemented using a single optical system or machine in connection with the illumination device. The high NA disclosed for illumination and collection permits the implementation of imaging modes using the same optical system, thereby allowing optimization of imaging for different types of defects or samples.

The imaging subsystem also includes intermediate image forming optics 1115. The purpose of the image forming optics 1115 is to form an internal image 1116 of the sample 1114. At this internal image 1116, a mirror 1117 can be placed to redirect light corresponding to one of the inspection modes. It is possible to redirect the light at this location because the light for the imaging modes are spatially separate. The image forming optics 1118 and 1120 can be implemented in several different forms including a varifocal zoom, multiple afocal tube lenses with focusing optics, or multiple image forming mag tubes. U.S. Published Application 2009/0180176, which published on Jul. 16, 2009 and is incorporated by reference herein, describes additional details regarding system 1100.

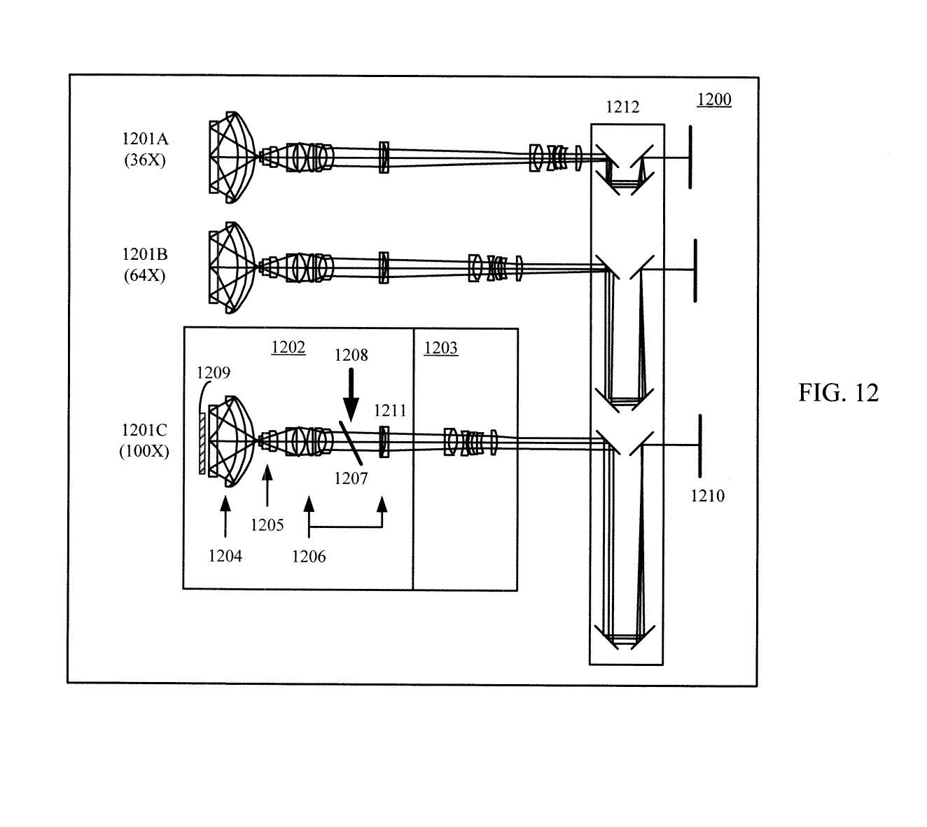

FIG. 12 illustrates an exemplary ultra-broadband UV microscope imaging system 1200 including three sub-sections 1201A, 1201B, and 1201C. Sub-section 1201C includes a catadioptric objective section 1202 and a zooming tube lens group section 1203. Catadioptric objective section 1202 includes a catadioptric lens group 1204, a field lens group 1205, and a focusing lens group 1206. System 1200 can image an object/sample 1209 (e.g. a wafer being inspected) to an image plane 1210.

Catadioptric lens group 1204 includes a near planar (or planar) reflector (which is a reflectively coated lens element), a meniscus lens (which is a refractive surface), and a concave spherical reflector. Both reflective elements can have central optical apertures without reflective material to allow light from an intermediate image plane to pass through the concave spherical reflector, be reflected by the near planar (or planar) reflector onto the concave spherical reflector, and pass back through the near planar (or planar) reflector, traversing the associated lens element or elements on the way. Catadioptric lens group 1204 is positioned to form a real image of the intermediate image, such that, in combination with focusing lens group 1203, primary longitudinal color of the system is substantially corrected over the wavelength band.

Field lens group 1205 can be made from two or more different refractive materials, such as fused silica and fluoride glass, or diffractive surfaces. Field lens group 1205 may be optically coupled together or alternatively may be spaced slightly apart in air. Because fused silica and fluoride glass do not differ substantially in dispersion in the deep ultraviolet range, the individual powers of the several component element of the field lens group need to be of high magnitude to provide different dispersions. Field lens group 1205 has a net positive power aligned along the optical path proximate to the intermediate image. Use of such an achromatic field lens allows the complete correction of chromatic aberrations including at least secondary longitudinal color as well as primary and secondary lateral color over an ultra-broad spectral range. In one embodiment, only one field lens component need be of a refractive material different than the other lenses of the system.

Focusing lens group 1206 includes multiple lens elements, preferably all formed from a single type of material, with refractive surfaces having curvatures and positions selected to correct both monochromatic aberrations and chromatic variation of aberrations and focus light to an intermediate image. In one embodiment of focusing lens group 1206, a combination of lenses 1211 with low power corrects for chromatic variation in spherical aberration, coma, and astigmatism. A beam splitter 1207 provides an entrance for a UV light source 1208. UV light source 1208 can advantageously be implemented by the solid-state 193 nm laser described above.

Zooming tube lens section 1203 can be all the same refractive material, such as fused silica, and is designed so that primary longitudinal and primary lateral colors do not change during zooming. These primary chromatic aberrations do not have to be corrected to zero, and cannot be if only one glass type is used, but they have to be stationary, which is possible. Then the design of the catadioptric objective 1202 must be modified to compensate for these uncorrected but stationary chromatic aberrations of zooming tube lens section 1203. Zooming tube lens group 1203, which can zoom or change magnification without changing its higher-order chromatic aberrations, includes lens surfaces disposed along an optical path of the system.

In one preferred embodiment, zooming tube lens section 1203 is first corrected independently of catadioptric objective 1202 using two refractive materials (such as fused silica and calcium fluoride). Zooming tube lens section 1203 is then combined with catadioptric objective 1202, at which time catadioptric objective 1202 can be modified to compensate for the residual higher-order chromatic aberrations of system 1200. This compensating is possible because of field lens group 1205 and low power lens group 1211. The combined system is then optimized with all parameters being varied to achieve the best performance.

Note that sub-sections 1201A and 1201B include substantially similar components to that of sub-section 1201C and therefore are not discussed in detail.

System 1200 includes a folding mirror group 1212 to provide linear zoom motion that allows a zoom from 36× to 100×. The wide range zoom provides continuous magnification change, whereas the fine zoom reduces aliasing and allows electronic image processing, such as cell-to-cell subtraction for a repeating image array. Folding mirror group 1212 can be characterized as a “trombone” system of reflective elements. Zooming is done by moving the group of 6 lenses 1203, as a unit, and also moving the arm of the trombone slide. Because the trombone motion only affects focus and the f# speed at its location is very slow, the accuracy of this motion could be very loose. One advantage of this trombone configuration is that it significantly shortens the system. Another advantage is that there is only one zoom motion that involves active (non-flat) optical elements. And the other zoom motion, with the trombone slide, is insensitive to errors. U.S. Pat. No. 5,999,310, which issued on Dec. 7, 1999 and is incorporated by reference herein, describes system 1200 in further detail.

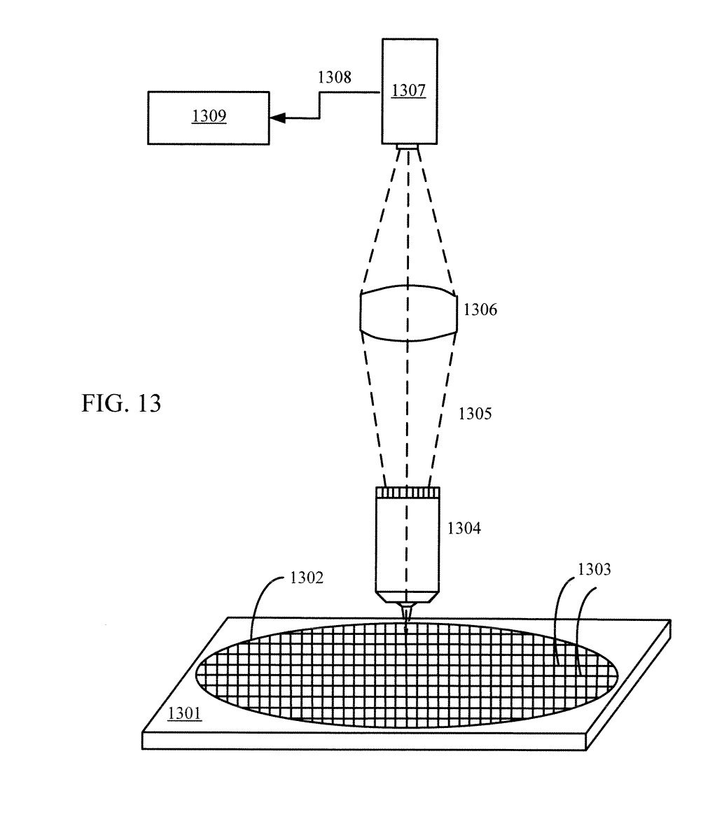

FIG. 13 illustrates an exemplary catadioptric bright-field imaging system 1300 including a zoom for the inspection of semiconductor wafers. Platform 1301 holds a wafer 1302 that is composed of integrated circuit dice 1303. A catadioptric objective 1304 transfers a light ray bundle 1305 to a zooming tube lens 1306, which produces an adjustable image received by a detector 1307. Detector 1307 converts the image to binary coded data and transfers the data over a cable 1308 to a data processor 1309. In one embodiment, catadioptric objective 1304 and zooming tube lens 1306 form part of a system substantially similar to that of system 1200 (FIG. 12), which receives 193 nm light generated by the solid-state laser described above.

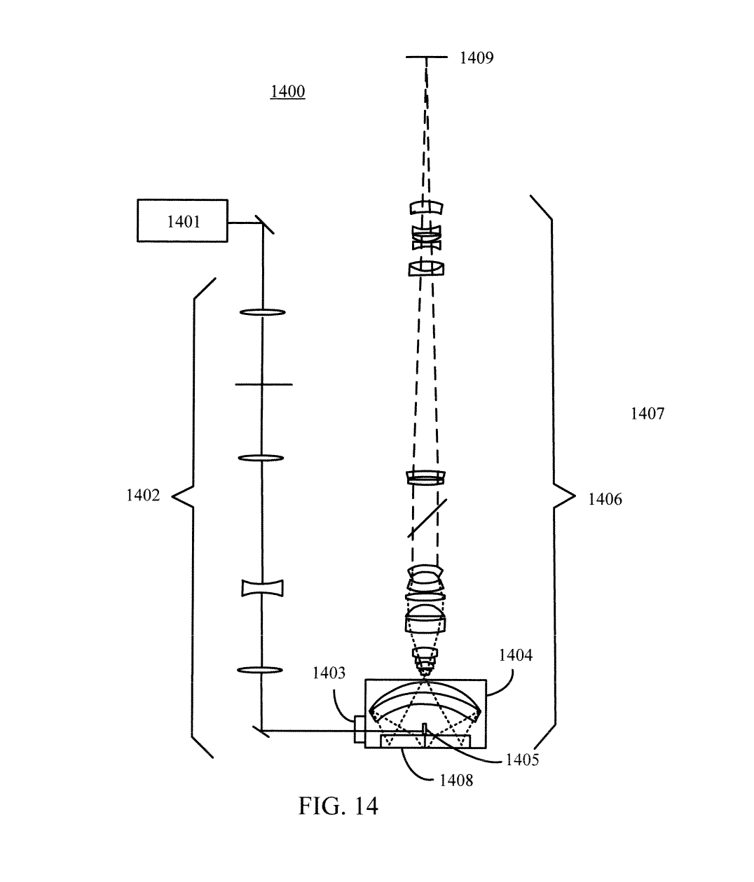

FIG. 14 illustrates the addition of a normal incidence laser dark-field illumination to a catadioptric imaging system 1400. The dark-field illumination includes a UV laser 1401, adaptation optics 1402 to control the illumination beam size and profile on the surface being inspected, an aperture and window 1403 in a mechanical housing 1404, and a prism 1405 to redirect the laser along the optical axis at normal incidence to the surface of a sample 1408. Prism 1405 also directs the specular reflection from surface features of sample 1408 and reflections from the optical surfaces of an objective 1406 along the optical path to an image plane 1409. Lenses for objective 1406 can be provided in the general form of a catadioptric objective, a focusing lens group, and a zooming tube lens section (see, e.g. FIG. 12). In a preferred embodiment, laser 1401 can be implemented by the above-described solid-state 193 nm laser. Published Patent Application 2007/0002465, which published on January 4, 2007 and is incorporated by reference herein, describes system 1400 in further detail.

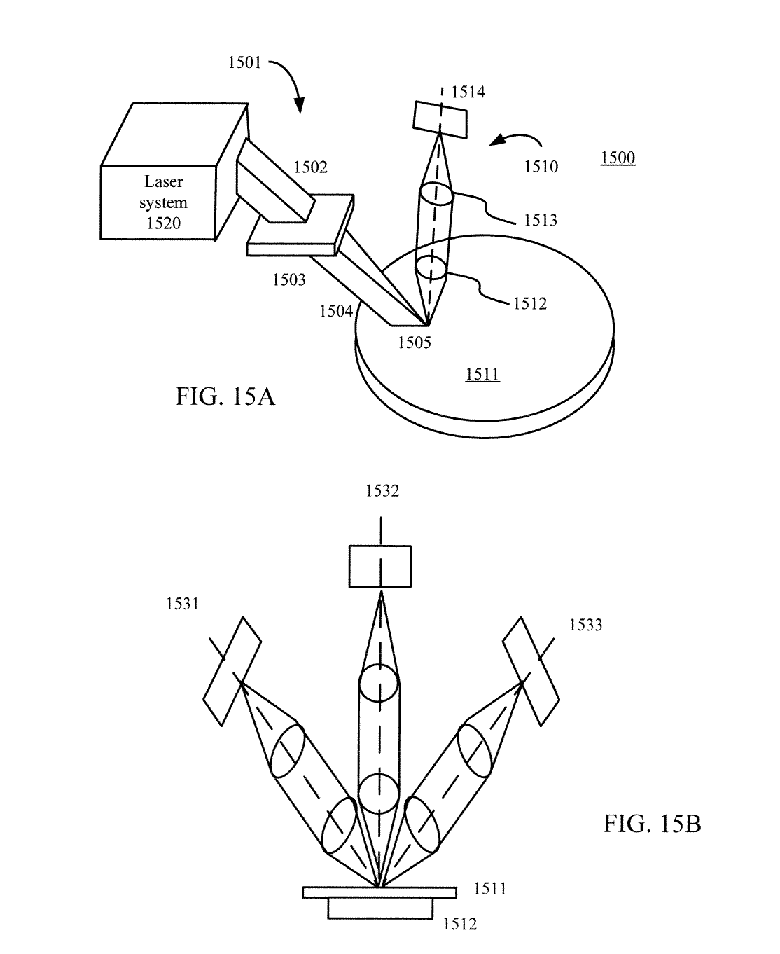

FIG. 15A illustrates a surface inspection apparatus 1500 that includes illumination system 1501 and collection system 1510 for inspecting areas of surface 1511. As shown in FIG. 15A, a laser system 1520 directs a light beam 1502 through a lens 1503. In a preferred embodiment, laser system 1520 includes the above-described solid-state 193 nm laser, an annealed crystal, and a housing to maintain the annealed condition of the crystal during standard operation at a low temperature. First beam shaping optics can be configured to receive a beam from the laser and focus the beam to an elliptical cross section at a beam waist in or proximate to the crystal. A harmonic separation block can be configured to receive an output from the crystal and generate therefrom multiple beams (see FIG. 15B) and at least one undesired frequency beam.

Lens 1503 is oriented so that its principal plane is substantially parallel to a sample surface 1511 and, as a result, illumination line 1505 is formed on surface 1511 in the focal plane of lens 1503. In addition, light beam 1502 and focused beam 1504 are directed at a non-orthogonal angle of incidence to surface 1511. In particular, light beam 1502 and focused beam 1504 may be directed at an angle between about 1 degree and about 85 degrees from a normal direction to surface 1511. In this manner, illumination line 1505 is substantially in the plane of incidence of focused beam 1504.

Collection system 1510 includes lens 1512 for collecting light scattered from illumination line 1505 and lens 1513 for focusing the light coming out of lens 1512 onto a device, such as charge coupled device (CCD) 1514, comprising an array of light sensitive detectors. In one embodiment, CCD 1514 may include a linear array of detectors. In such cases, the linear array of detectors within CCD 1514 can be oriented parallel to illumination line 1515. In one embodiment, multiple collection systems can be included, wherein each of the collection systems includes similar components, but differ in orientation.

For example, FIG. 15B illustrates an exemplary array of collection systems 1531, 1532, and 1533 for a surface inspection apparatus (wherein its illumination system, e.g. similar to that of illumination system 1501, is not shown for simplicity). First optics in collection system 1531 can direct a first beam of radiation along a first path onto a first spot on the surface of sample 1511. Second optics in collection system 1532 can direct a second beam of radiation along a second path onto a second spot on the surface of sample 1511. Third optics in collection system 1533 can direct a third beam of radiation along a third path onto a third spot on the surface of sample 1511. Note that the first, second, and third paths are at different angles of incidence to said surface of sample 1511. A platform 1512 supporting sample 1511 can be used to cause relative motion between the multiple beams and sample 1511 so that the spots are scanned across the surface of sample 1511. U.S. Pat. No. 7,525,649, which issued on Apr. 28, 2009 and is incorporated by reference herein, describes surface inspection apparatus 1500 and other multiple collection systems in further detail.

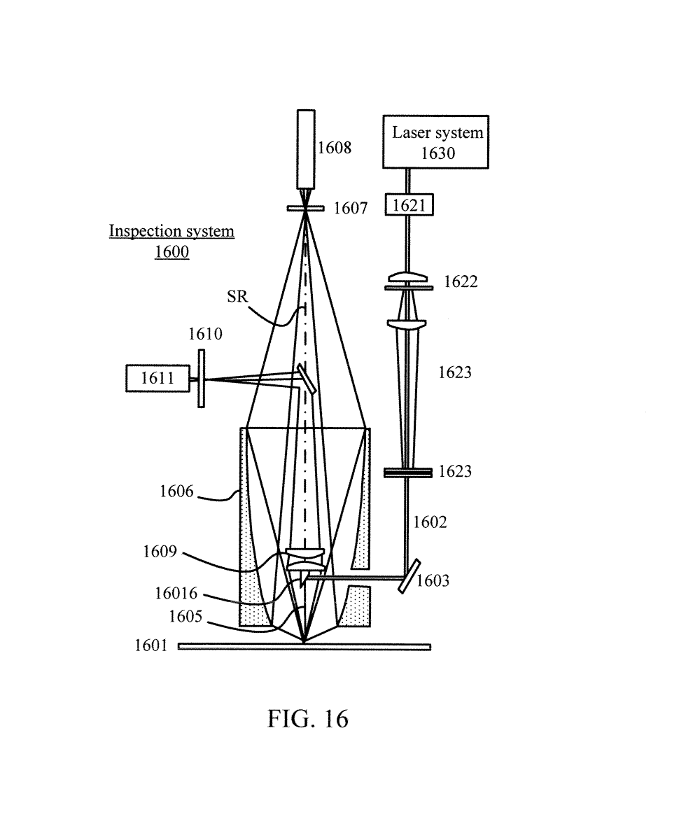

FIG. 16 illustrates a surface inspection system 1600 that can be used for inspecting anomalies on a surface 1601. In this embodiment, surface 1601 can be illuminated by a substantially stationary illumination device portion of a laser system 1630 comprising a laser beam generated by the above-described solid-state 193 nm laser. The output of laser system 1630 can be consecutively passed through polarizing optics 1621, a beam expander and aperture 1622, and beam-forming optics 1623 to expand and focus the beam.

The focused laser beam 1602 is then reflected by a beam folding component 1603 and a beam deflector 1604 to direct the beam 1605 towards surface 1601 for illuminating the surface. In the preferred embodiment, beam 1605 is substantially normal or perpendicular to surface 1601, although in other embodiments beam 1605 may be at an oblique angle to surface 1601.

In one embodiment, beam 1605 is substantially perpendicular or normal to surface 1601 and beam deflector 1604 reflects the specular reflection of the beam from surface 1601 towards beam turning component 1603, thereby acting as a shield to prevent the specular reflection from reaching the detectors. The direction of the specular reflection is along line SR, which is normal to the surface 1601 of the sample. In one embodiment where beam 1605 is normal to surface 1601, this line SR coincides with the direction of illuminating beam 1605, where this common reference line or direction is referred to herein as the axis of inspection system 1600. Where beam 1605 is at an oblique angle to surface 1601, the direction of specular reflection SR would not coincide with the incoming direction of beam 1605; in such instance, the line SR indicating the direction of the surface normal is referred to as the principal axis of the collection portion of inspection system 1600.

Light scattered by small particles are collected by mirror 1606 and directed towards aperture 1607 and detector 1608. Light scattered by large particles are collected by lenses 1609 and directed towards aperture 1610 and detector 1611. Note that some large particles will scatter light that is also collected and directed to detector 1607, and similarly some small particles will scatter light that is also collected and directed to detector 1611, but such light is of relatively low intensity compared to the intensity of scattered light the respective detector is designed to detect. In one embodiment, detector 1611 can include an array of light sensitive elements, wherein each light sensitive element of the array of light sensitive elements is configured to detect a corresponding portion of a magnified image of the illumination line. In one embodiment, inspection system can be configured for use in detecting defects on unpatterned wafers. U.S. Pat. No. 6,271,916, which issued on Aug. 7, 2011 and is incorporated by reference herein, describes inspection system 1600 in further detail.

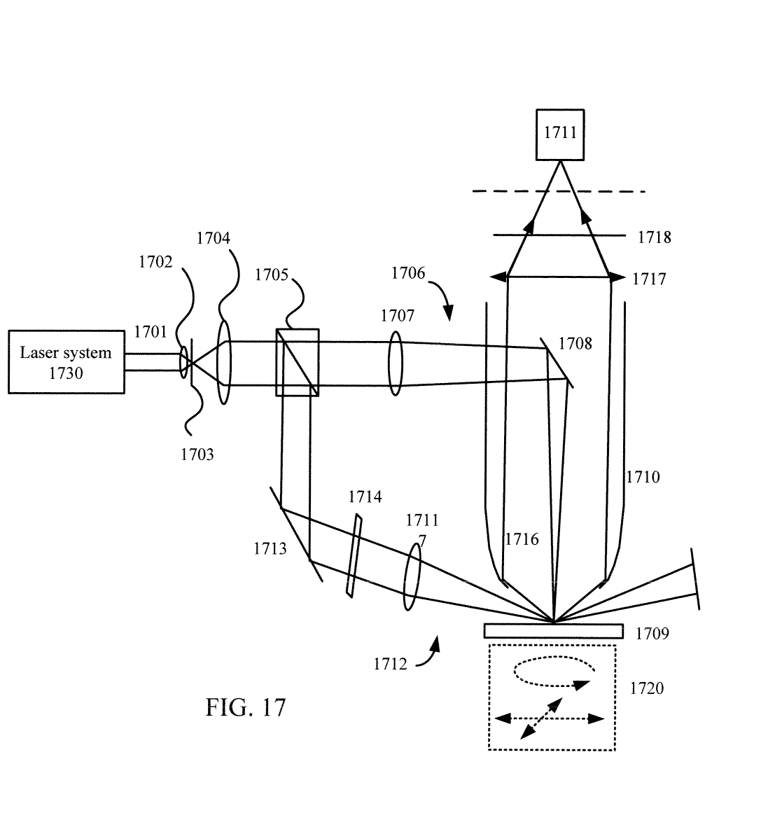

FIG. 17 illustrates an inspection system 1700 configured to implement anomaly detection using both normal and oblique illumination beams. In this configuration, a laser system 1730, which includes the above-described solid-state 193 nm laser, can provide a laser beam 1701. A lens 1702 focuses the beam 1701 through a spatial filter 1703 and lens 1704 collimates the beam and conveys it to a polarizing beam splitter 1705. Beam splitter 1705 passes a first polarized component to the normal illumination channel and a second polarized component to the oblique illumination channel, where the first and second components are orthogonal. In the normal illumination channel 1706, the first polarized component is focused by optics 1707 and reflected by mirror 1708 towards a surface of a sample 1709. The radiation scattered by sample 509 is collected and focused by a paraboloidal mirror 1710 to a photomultiplier tube 1711.

In the oblique illumination channel 1712, the second polarized component is reflected by beam splitter 1705 to a mirror 1713 which reflects such beam through a half-wave plate 1714 and focused by optics 1715 to sample 1709. Radiation originating from the oblique illumination beam in the oblique channel 1712 and scattered by sample 1709 is collected by paraboloidal mirror 1710 and focused to photomultiplier tube 1711. Photomultiplier tube 1711 has a pinhole entrance. The pinhole and the illuminated spot (from the normal and oblique illumination channels on surface 1709) are preferably at the foci of the paraboloidal mirror 1710.

The paraboloidal mirror 1710 collimates the scattered radiation from sample 1709 into a collimated beam 1716. Collimated beam 1716 is then focused by an objective 1717 and through an analyzer 1718 to the photomultiplier tube 1711. Note that curved mirrored surfaces having shapes other than paraboloidal shapes may also be used. An instrument 1720 can provide relative motion between the beams and sample 1709 so that spots are scanned across the surface of sample 1709. U.S. Pat. No. 6,201,601, which issued on Mar. 13, 2001 and is incorporated by reference herein, describes inspection system 1700 in further detail.

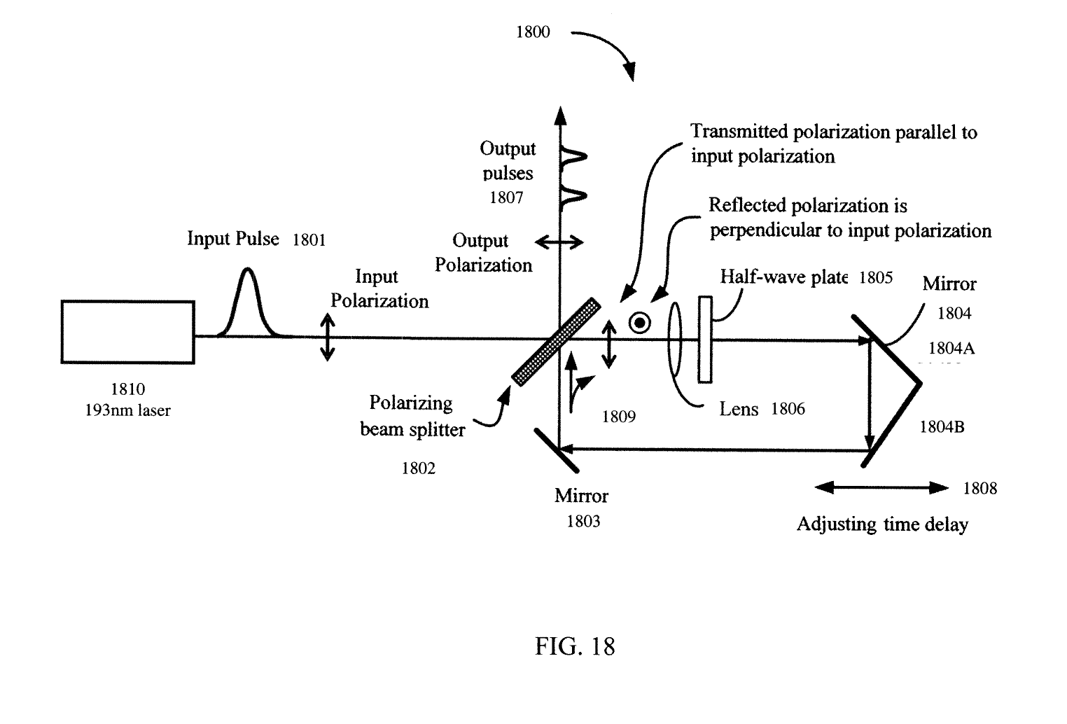

FIG. 18 illustrates an exemplary pulse multiplier 1800 for use with the above-described laser in an inspection or metrology system. Pulse multiplier 1800 is configured to generate pulse trains from each input pulse 1801 from 193 nm laser 1810. Input pulse 1801 impinges on a polarizing beam splitter 1802, which because of the input polarization of input pulse 1801, transmits all of its light to a lens 1806. Thus, the transmitted polarization is parallel to the input polarization of input pulse 1801. Lens 1806 focuses and directs the light of input pulse 1801 to a half-wave plate 1805. In general, a wave plate can shift the phases between perpendicular polarization components of a light wave. For example, a half-wave plate receiving linearly polarized light can generate two waves, one wave parallel to the optical axis and another wave perpendicular to the optical axis. In half-wave plate 1805, the parallel wave can propagate slightly slower than the perpendicular wave. Half-wave plate 105 is fabricated such that for light exiting, one wave is exactly half of a wavelength delayed (180 degrees) relative to the other wave.

Thus, half-wave plate 1805 can generate pulse trains from each input pulse 1801. The normalized amplitudes of the pulse trains are: cos2θ (wherein θ is the angle of half-wave plate 1805), sin²2θ, sin²2θcos2θ, sin²2θcos²2θ, sin²2θcos³2θ, sin²2θcos⁴2θ, sin²2θcos⁵2θ, etc. Notably, the total energy of the pulse trains from a laser pulse can be substantially conserved traversing half-wave plate 1805.

The sum of the energy from the odd terms generated by half-wave plate 1805 is equal to:

$${( cos 2 θ )}^{2} + {( {sin}^{2} 2 θcos2θ )}^{2} + {( {sin}^{2} 2 {θcos}^{3} 2 θ )}^{2} + {( {sin}^{2} 2 {θcos}^{5} 2 θ )}^{2} + ( {sin}^{2} 2 {θcos}^{7} 2 θ ) 2 + {( {sin}^{2} 2 {θcos}^{9} 2 θ )}^{2} + … = {cos }^{2} 2 θ + {sin}^{4} 2 θ ( {cos}^{2} 2 θ + {cos}^{6} 2 θ + {cos}^{10} 2 θ + … ) = 2 {cos}^{2} 2 θ / ( 1 + {cos}^{2} 2 θ )$$

In contrast, the sum of the energy from the even terms generated by half-wave plate 1805 is equal to:

$${( {sin}^{2} 2 θ )}^{2} + {( {sin}^{2} 2 {θcos}^{2} 2 θ )}^{2} + {( {sin}^{2} 2 {θcos}^{4} 2 θ )}^{2} + {( {sin}^{2} 2 {θcos}^{6} 2 θ )}^{2} + {( {sin}^{2} 2 {θcos}^{8} 2 θ )}^{2} + {( {sin}^{2} 2 {θcos}^{10} 2 θ )}^{2} + … = {sin}^{4} 2 θ ( 1 + {cos}^{4} 2 θ + {cos}^{8} 2 θ + {cos}^{12} 2 θ + … ) = {sin}^{2} 2 θ / ( 1 + {cos}^{2} 2 θ )$$

In accordance with one aspect of pulse multiplier 1800, the angle θ of half-wave plate 1805 can be determined (as shown below) to provide that the odd term sum is equal to the even term sum.

2cos²2θ=sin²2θ
cos²2θ=⅓
sin²2θ=⅔
θ=27.3678 degrees

Referring back to FIG. 18, the light exiting half-wave plate 1805 is reflected by mirrors 1804 and 1803 back to polarizing beam splitter 1802. Thus, polarizing beam splitter 1802, lens 1806, half-wave plate 1805, and mirrors 1804 and 1803 form a ring cavity configuration. The light impinging on polarizing beam splitter 1802 after traversing the ring cavity has two polarizations as generated by half-wave plate 1805. Therefore, polarizing beam splitter 1802 transmits some light and reflects other light, as indicated by arrows 1809. Specifically, polarizing beam splitter 1802 transmits the light from mirror 1803 having the same polarization as input pulse 1801. This transmitted light exits pulse multiplier 1800 as output pulses 1807. The reflected light, which has a polarization perpendicular to that of input pulse 1801, is re-introduced into the ring cavity (pulses not shown for simplicity).

Notably, these re-introduced pulses can traverse the ring in the manner described above with further partial polarization switching by half-wave plate 1805 and then light splitting by polarizing beam splitter 1802. Thus, in general, the above-described ring cavity is configured to allow some light to exit and the rest of the light (with some minimal losses) to continue around the ring. During each traversal of the ring (and without the introduction of additional input pulses), the energy of the total light decreases due to the light exiting the ring as output pulses 1807.

Periodically, a new input pulse 1801 is provided by laser 1810 to pulse multiplier 1800. In one embodiment, for a 125 MHz laser input, 0.1 nanosecond (ns) laser pulses result. Note that the size of the ring, and thus the time delay of the ring, can be adjusted by moving mirror 1804 along the axis indicated by arrows 1808.

The ring cavity length may be slightly greater than, or slightly less than, the nominal length calculated directly from the pulse interval divided by the multiplication factor. This results in the pulses not arriving at exactly the same time as the polarized beam splitter and slightly broadens the output pulse. For example, when the input pulse repetition rate is 125 MHz, the cavity delay would nominally be 4 ns for a frequency multiplication by 2. In one embodiment, a cavity length corresponding to 4.05 ns can be used so that the multiply reflected pulses do not arrive at exactly the same time as an incoming pulse. Moreover, the 4.05 ns cavity length for the 125 MHz input pulse repetition rate can also advantageously broaden the pulse and reduce pulse height. Other pulse multipliers having different input pulse rates can have different cavity delays.

Notably, polarizing beam splitter 1802 and half-wave plate 1805 working in combination generate even and odd pulses, which diminish for each round traversed inside the ring. These even and odd pulses can be characterized as providing energy envelopes, wherein an energy envelope consists of an even pulse train (i.e. a plurality of even pulses) or an odd pulse train (i.e. a plurality of odd pulses). In accordance with one aspect of pulse multiplier 1800, these energy envelopes are substantially equal.

More details of pulse multiplication can be found in copending U.S. patent application Ser. No. 13/371,704, entitled “Semiconductor Inspection And Metrology System Using Laser Pulse Multiplier” and filed Jun. 1, 2012, which is incorporated by reference herein.

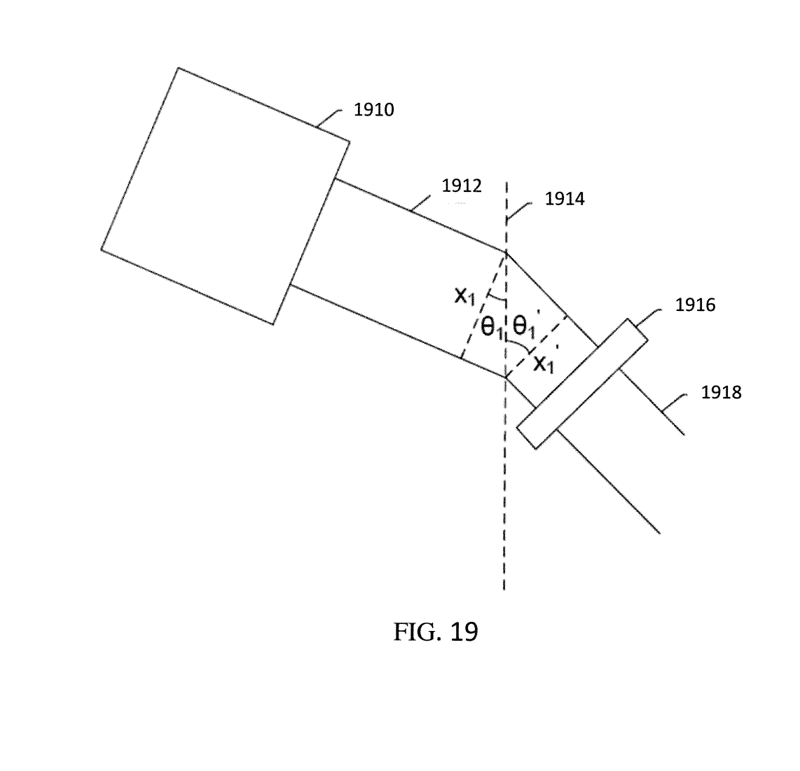

FIG. 19 illustrates a coherence reducing subsystem for use with the above described 193 nm laser 1910 in an inspection or metrology system. One aspect of this embodiment is to make use of the finite spectral range of the laser in order to perform a substantially quick temporal modulation of the light beam 1912, which can be changed on the required tenth picosecond time intervals (a tenth picoseconds time interval is equivalent to a few nm in spectral width), and transform the temporal modulation to spatial modulation.

The use of a dispersive element and an electro-optic modulator is provided for speckle reduction. For example, the illumination subsystem includes a dispersive element positioned in the path of the coherent pulses of light. As shown in FIG. 19, the dispersive element can be positioned at plane 1914 arranged at angle θ₁ to the cross-section of the coherent pulses of light. As further shown in FIG. 19, the pulses of light exit the dispersive element at angle θ₂ and with cross-sectional dimension X′₁. In one embodiment, the dispersive element is a prism. In another embodiment, the dispersive element is a diffraction grating. The dispersive element is configured to reduce coherence of the pulses of light by mixing spatial and temporal characteristics of light distribution in the pulses of light. In particular, a dispersive element such as a prism or diffraction grating provides some mixing between spatial and temporal characteristics of the light distribution in the pulses of light. For example, a diffraction grating transforms a separate dependence of the light distribution in the pulses of light on spatial and temporal coordinates to a dependence of the light distribution on mixed spatial-temporal coordinates:

E(t,x) [symbol] E(t−βx,x).

The dispersive element may include any suitable prism or diffraction grating, which may vary depending on the optical characteristics of the illumination subsystem and the metrology or inspection system.

The illumination subsystem further includes an electro-optic modulator positioned in the path of the pulses of light exiting the dispersive element. For example, as shown in FIG. 19, the illumination subsystem may include electro-optic modulator 1916 positioned in the path of the pulses of light exiting the dispersive element. The electro-optic modulator is configured to reduce the coherence of the pulses of light by temporally modulating the light distribution in the pulses of light. In particular, the electro-optic modulator provides an arbitrary temporal modulation of the light distribution. Therefore, the dispersive element and the electro-optic modulator have a combined effect on the pulses of light generated by the light source. In particular, the combination of the dispersive element with the electro-optic modulator creates an arbitrary temporal modulation and transforms the temporal modulation to an arbitrary spatial modulation of the output beam 1918.

In one embodiment, the electro-optic modulator is configured to change the temporal modulation of the light distribution in the pulses of light at tenth picosecond time intervals. In another embodiment, the electro-optic modulator is configured to provide about 10³ aperiodic samples on each period thereby providing a de-coherence time of about 10⁻¹³ seconds. For example, an electro-optic modulator introduces the following time varying phasor, exp(iφₘsin(ωₘt)), where ωₘ˜10⁹-10¹⁰ Hz is the modulation frequency,

$${φ}_{m} = \frac{2 π}{λ} Δ n \cdot l ,$$

l is the thickness of the electro-optic modulator, λ is the wavelength, and Δn˜10⁻³ is the amplitude of the change of the refractive index. An electro-optic modulator with a frequency of ˜10⁹-10¹⁰ Hz provides the minimal de-coherence time τ_{D}˜10⁻¹⁰ which is 3 orders of magnitude larger than the required tenth picosecond time. However, a relatively high amplitude (φₘ˜10³) may provide ˜10³ aperiodic samples on each period and in this manner may reduce the de-coherence time to a desirable τ_{D}˜10⁻¹³ seconds.

Further details of the coherence and speckle reducing apparatus and methods are disclosed in co-pending published PCT application WO 2010/037106 and co-pending U.S. application Ser. No. 13/073,986 both by Chuang et al., both of which are incorporated by reference as if fully set forth herein.

One difficult part of a solid-state deep-UV laser is the final conversion state. The above-described solid-state 193 nm laser, which uses the 6^{th} harmonic, enables the use of substantially non-critical phase matching for that final frequency conversion. Near non-critical phase matching is more efficient and more stable than critical phase matching because a longer crystal can be used and is less affected by small changes in alignment. Note that the longer crystal also allows the use of lower peak power densities in the crystal while maintaining the same overall conversion efficiency, thereby slowing damage accumulation to the crystal. Notably, 6^{th} harmonic generation is less complex and more efficient than 8^{th} harmonic generation. Therefore, the above-described solid-state 193 nm laser, which uses the 6^{th} harmonic, can provide significant system advantages during photomask, reticle, or wafer inspection.

Although the above describes an approximately 1160 nm fundamental wavelength resulting in a 6^{th} harmonic of 193.3 nm, it is to be understood that other wavelengths within a few nm of 193.3 nm could be generated by this approach using an appropriate choice of fundamental wavelength. Such lasers and systems utilizing such lasers are within the scope of this invention.

The various embodiments of the structures and methods of this invention that are described above are illustrative only of the principles of this invention and are not intended to limit the scope of the invention to the particular embodiments described. For example, non-linear crystals other than CLBO, LBO, or BBO or periodically-poled materials can be used for some of the frequency conversion stages. Thus, the invention is limited only by the following claims and their equivalents.

1. A laser for generating approximately 193 nm wavelength light, the laser comprising:
a seed laser generating a fundamental frequency of approximately 1160 nm;
a first stage for combining portions of the fundamental frequency to generate a second harmonic frequency;
a second stage for combining portions of the second harmonic frequency to generate a fourth harmonic frequency;
a third stage for combining the fundamental frequency and the fourth harmonic frequency to generate a fifth harmonic frequency; and
a fourth stage for combining the fundamental frequency and the fifth harmonic frequency to generate a sixth harmonic frequency of approximately 193.3 nm.

2. The laser of claim 1, further including an optical amplifier for amplifying the fundamental frequency.

3. The laser of claim 2, wherein the optical amplifier includes one of a doped photonic band-gap fiber optical amplifier, a doped fiber optical amplifier, a Germania-doped Raman amplifier, and an undoped silica fiber Raman amplifier.

4. The laser of claim 1, wherein the seed laser includes one of a Raman fiber laser, a low-power, ytterbium (Yb)-doped fiber, and an infra-red diode laser.

5. The laser of claim 1, further including beam splitters for providing the fundamental frequency to the first, third, and fourth stages.

6. The laser of claim 4, wherein said laser diode uses quantum dot technology.

7. The laser of claim 1, further including a set of mirrors for directing unconsumed harmonics to appropriate stages.

8. The laser of claim 1, wherein the first stage includes a Lithium triborate (LBO) crystal.

9. The laser of claim 1, wherein each of the second, third, and fourth stages includes a Cesium Lithium Borate (CLBO) crystal.

10. The laser of claim 1, wherein the at least one of the second, third, and fourth stages includes an annealed Cesium Lithium Borate (CLBO) crystal.

11. The laser of claim 1, further including an amplifier pump for pumping the optical amplifier.

12. The laser of claim 11, wherein the amplifier pump includes a ytterbium-doped fiber laser operating at approximately 1100 nm.

13. The laser of claim 11, wherein the amplifier pump includes one of a ytterbium-doped fiber laser and a neodymium-doped yttrium lithium fluoride laser operating between 1040-1070 nm.

14. A method of generating approximately 193 nm wavelength light, the method comprising:
generating a fundamental frequency of approximately 1160 nm;
combining portions of the fundamental frequency to generate a second harmonic frequency;
combining portions of the second harmonic frequency to generate a fourth harmonic frequency;
combining the fundamental frequency and the fourth harmonic frequency to generate a fifth harmonic frequency;
combining the fundamental frequency and the fifth harmonic frequency to generate a sixth harmonic frequency of approximately 193.3 nm.

15. The method of claim 1, further including amplifying the fundamental frequency.

16. An optical inspection system for inspecting a surface of a photomask, reticle, or semiconductor wafer for defects, the system comprising:
a light source for emitting an incident light beam along an optical axis, the light source including a 6^{th} harmonic generator for generating 193 nm wavelength light;
an optical system disposed along the optical axis and including a plurality of optical components for directing the incident light beam to a surface of the photomask, reticle or semiconductor wafer, the optical system being configured to scan the surface;
a transmitted light detector arrangement including transmitted light detectors, the transmitted light detectors being arranged for sensing a light intensity of transmitted light; and
a reflected light detector arrangement including reflected light detectors, the reflected light detectors being arranged for sensing a light intensity of reflected light.

17. An inspection system for inspecting a surface of a sample, the inspection system comprising:
an illumination subsystem configured to produce a plurality of channels of light, each channel of light produced having differing characteristics from at least one other channel of light energy, the illumination subsystem including a 6^{th} harmonic generator for generating 193 nm wavelength light for at least one channel;
optics configured to receive the plurality of channels of light and combine the plurality of channels of light energy into a spatially separated combined light beam and direct the spatially separated combined light beam toward the sample; and
a data acquisition subsystem comprising at least one detector configured to detect reflected light from the sample,
wherein the data acquisition subsystem is configured to separate the reflected light into a plurality of received channels corresponding to the plurality of channels of light.

18. A catadioptric inspection system comprising:
an ultraviolet (UV) light source for generating UV light, the UV light source including a 6^{th} harmonic generator for generating 193 nm wavelength light;
a plurality of imaging sub-sections, each sub-section including:
a focusing lens group including a plurality of lens elements disposed along an optical path of the system to focus the UV light at an intermediate image within the system and simultaneously to provide correction of monochromatic aberrations and chromatic variation of aberrations over a wavelength band including at least one wavelength in an ultraviolet range, the focusing lens group further including a beam splitter positioned to receive the UV light;
a field lens group with a net positive power aligned along the optical path proximate to the intermediate image, the field lens group including a plurality of lens elements with different dispersions, with lens surfaces disposed at second predetermined positions and having curvatures selected to provide substantial correction of chromatic aberrations including at least secondary longitudinal color as well as primary and secondary lateral color of the system over the wavelength band;
a catadioptric lens group including at least two reflective surfaces and at least one refractive surface disposed to form a real image of the intermediate image, such that, in combination with the focusing lens group, primary longitudinal color of the system is substantially corrected over the wavelength band; and
a zooming tube lens group, which can zoom or change magnification without changing its higher-order chromatic aberrations, including lens surfaces disposed along one optical path of the system; and
a folding mirror group configured to allow linear zoom motion, thereby providing both fine zoom and wide range zoom.

19. A catadioptric imaging system with dark-field illumination, the system comprising:
an ultraviolet (UV) light source for generating UV light, the UV light source including a 6^{th} harmonic generator for generating 193 nm wavelength light;
adaptation optics;
an objective including a catadioptric objective, a focusing lens group, and a zooming tube lens section; and
a prism for directing the UV light along the optical axis at normal incidence to a surface of a sample and directing specular reflections from surface features of the sample as well as reflections from optical surfaces of the objective along an optical path to an imaging plane.

20. An optical system for detecting anomalies of a sample, the optical system comprising:
a laser system for generating first and second beams, the laser system comprising:
a light source including a 6^{th} harmonic generator for generating 193 nm wavelength light;
an annealed, frequency-conversion crystal;
a housing to maintain an annealed condition of the crystal during standard operation at a low temperature;
first beam shaping optics configured to receive a beam from the light source and focus the beam to an elliptical cross section at a beam waist in or proximate to the crystal; and
a harmonic separation block to receive an output from the crystal and generate therefrom the first and second beams and at least one undesired frequency beam;
first optics directing the first beam of radiation along a first path onto a first spot on a surface of the sample;
second optics directing the second beam of radiation along a second path onto a second spot on a surface of the sample, said first and second paths being at different angles of incidence to said surface of the sample;
a first detector;
collection optics including a curved mirrored surface receiving scattered radiation from the first or the second spot on the sample surface and originating from the first or second beam and focusing the scattered radiation to the first detector, the first detector providing a single output value in response to the radiation focused onto it by said curved mirrored surface; and
an instrument causing relative motion between the first and second beams and the sample so that the spots are scanned across the surface of the sample.

21. A surface inspection apparatus, comprising:
a laser system for generating a beam of radiation at 193 nm, the laser system comprising a solid-state laser including a 6^{th} harmonic generator for generating the beam of radiation;
an illumination system configured to focus the beam of radiation at a non-normal incidence angle relative to a surface to form an illumination line on the surface substantially in a plane of incidence of the focused beam, wherein the plane of incidence is defined by the focused beam and a direction that is through the focused beam and normal to the surface;
a collection system configured to image the illumination line, wherein the collection system comprises: an imaging lens for collecting light scattered from a region of the surface comprising the illumination line;
a focusing lens for focusing the collected light; and
a device comprising an array of light sensitive elements, wherein each light sensitive element of the array of light sensitive elements is configured to detect a corresponding portion of a magnified image of the illumination line.

22. A pulse multiplier comprising:
a laser system for generating an input laser pulse, the laser system comprising:
a light source at approximately 1160 nm;
a solid-state laser for receiving light from the light source and with a 6^{th} harmonic generator generating therefrom the input laser pulse at approximately 193 nm;
a polarizing beam splitter that receives the input laser pulse;
a wave plate for receiving light from the polarized beam splitter and generating a first set of pulses and a second set of pulses, the first set of pulses having a different polarization than the second set of pulses; and
a set of mirrors for creating a ring cavity including the polarizing beam splitter and the wave plate,
wherein the polarizing beam splitter transmits the first set of pulses as an output of the pulse multiplier and reflects the second set of pulses into the ring cavity.

23. An inspection system including the laser of claim 1 and further comprising at least one electro-optic modulator to reduce a coherence of the 193 nm wavelength light.

24. A laser for generating approximately 193 nm wavelength light, the laser comprising:
a seed laser generating a fundamental frequency of approximately 1160 nm;
a first stage for combining portions of the fundamental frequency to generate a second harmonic frequency;
a second stage for combining portions of the fundamental frequency and the second harmonic frequency to generate a third harmonic frequency;
a third stage for combining portions of the second harmonic frequency and the third harmonic frequency to generate a fifth harmonic frequency; and
a fourth stage for combining portions of the fundamental frequency and the fifth harmonic frequency to generate a sixth harmonic frequency of approximately 193.3nm.
